(19) United States
(12) Patent Application Publication
(10) Pub. No.: US 2022/0330334 A1
(43) Pub. Date: Oct. 13, 2022

(54) COMMUNICATION CONTROL DEVICE, COMMUNICATION DEVICE, COMMUNICATION CONTROL METHOD, AND COMMUNICATION METHOD

(71) Applicant: Sony Group Corporation, Tokyo (JP)

(72) Inventors: Yifu TANG, Tokyo (JP); Hiromasa UCHIYAMA, Tokyo (JP); Naoki KUSASHIMA, Tokyo (JP)

(73) Assignee: Sony Group Corporation, Tokyo (JP)

(21) Appl. No.: 17/638,185

(22) PCT Filed: Aug. 13, 2020
(86) PCT No.: PCT/JP2020/030746

§ 371 Date: Feb. 25, 2022

(30) Foreign Application Priority Data
Sep. 4, 2019 (JP) 2019-161589

(51) Int. Cl. H04W 74/08; H04W 74/00

(52) U.S. Cl. CPC H04W 74/0808; H04W 74/002; H04W 92/18

(57) ABSTRACT

A communication control device (30) according to the present disclosure includes a control unit (34). The control unit (34) notifies at least one of a first communication device (40₁) and a second communication device (40₂) of information on carrier sense in sidelink communication in an unlicensed band between the first communication device (40₁) and the second communication device (40₂).

### FIELD

The present disclosure relates to a communication control device, a communication device, a communication control method, and a communication method.

### BACKGROUND

In recent years, communication using a communication link between terminals, called sidelink, has emerged in addition to communication between a base station and a terminal device. One example of the communication using sidelink is device-to-device (D2D) communication, and there has been a lot of discussion about the communication using sidelink for use in use cases such as IoT and MTC, which are expected to increase in the future.

In a long term evolution (LTE) platform, device-to-device (D2D) communication in which terminal devices communicate directly with each other without a base station has been standardized in Release (Rel)-12 of third generation partnership project (3GPP) (See Non Patent Literature 1).

### CITATION LIST

### Non Patent Literature

Non Patent Literature 1: 3GPP Technical Report “TR 22.803 V12.1.0” March 2013

### SUMMARY

### Technical Problem

As described above, increase in the sidelink communication in the future probably leads to shortage of radio resources available for the sidelink communication. Therefore, there is a need for efficient use of radio resources.

In view of this, the present disclosure proposes a technology that enables efficient use of radio resources in device-to-device communication between terminal devices.

### Solution to Problem

According to the present disclosure, a communication control device is provided. The communication control device includes a control unit. The control unit notifies at least one of a first communication device and a second communication device of information on carrier sense in sidelink communication in an unlicensed band between the first communication device and the second communication device.

### BRIEF DESCRIPTION OF DRAWINGS

FIG. 1 is an explanatory diagram illustrating a case where UE is within a coverage range of eNB, and a case where UE is outside the coverage range thereof.

FIG. 2 is an explanatory diagram illustrating a case where UE belonging to operators A and B respectively, which are different MNOs, perform D2D communication with each other.

FIG. 3 is an explanatory diagram for explaining the position of a PSS/SSS.

FIG. 4 is an explanatory diagram illustrating the configuration of an LTE resource.

FIG. 5 is an explanatory diagram illustrating a resource pool.

FIG. 6 is a diagram for explaining an example of communication in LAA.

FIG. 7 is a diagram for explaining an outline of sidelink communication using an unlicensed band according to a first embodiment of the present disclosure.

FIG. 8 is a diagram illustrating an example of the configuration of an information processing system according to the first embodiment of the present disclosure.

FIG. 9 is a diagram illustrating an example of the specific configuration of an information processing system.

FIG. 10 is a diagram illustrating an example of the configuration of a management device according to the first embodiment of the present disclosure.

FIG. 11 is a diagram illustrating an example of the configuration of a base station device according to the first embodiment of the present disclosure.

FIG. 12 is a diagram illustrating an example of the configuration of a terminal device according to the first embodiment of the present disclosure.

FIG. 13 is a sequence diagram for explaining the flow of sidelink communication processing according to the first embodiment of the present disclosure.

FIG. 14 is a diagram illustrating an example of the configuration of a base station device according to a modification example 1 to the first embodiment of the present disclosure.

FIG. 15 is a diagram illustrating an example of the configuration of a terminal device according to the modification example 1 to the first embodiment of the present disclosure.

FIG. 16 is a sequence diagram for explaining the flow of sidelink communication processing according to the modification example 1 to the first embodiment of the present disclosure.

FIG. 17 is a diagram for explaining an outline of sidelink communication according to a second embodiment of the present disclosure.

FIG. 18 is a diagram illustrating an example of the configuration of a base station device according to the second embodiment of the present disclosure.

FIG. 19 is a diagram illustrating an example of the configuration of a master terminal according to the second embodiment of the disclosure.

FIG. 20 is a sequence diagram for explaining the flow of sidelink communication processing according to the second embodiment of the present disclosure.

### DESCRIPTION OF EMBODIMENTS

Hereinafter, embodiments of the present disclosure are described in detail with reference to the drawings. In the following embodiments, the same parts are denoted with the same reference numerals and repeated explanation of these parts is omitted.

Further, in the specification and the drawings, a plurality of constituent elements having substantially the same functional configuration is sometimes distinguished from one another by adding different numbers after the same reference numeral. For example, a plurality of configurations having substantially the same functional configuration is distinguished from one another as necessary, such as base station devices 20₁ and 20₂. However, if it is not necessary to distinguish the plurality of constituent elements having substantially the same functional configuration from one another, only the same reference numeral is given. For example, if it is not necessary to distinguish the base station devices 20₁ and 20₂ from one another, they are simply referred to as the base station device 20.

Further, the present disclosure is described in the following order of items.

### 1. Introduction

1-1. Outline of D2D communication

### 1-2. Outline of LAA

### 2. First Embodiment

### 2-1. Outline of First Embodiment

### 2-2. Configuration of Information Processing System

### 2-3. Flow of Sidelink Communication Processing

### 3. Modification Examples to First Embodiment

### 3-1. Modification Example 1

### 3-2. Modification Example 2

### 4. Second Embodiment

### 4-1. Outline of Second Embodiment

### 4-2. Configuration of Information Processing System

### 4-3. Flow of Sidelink Communication Processing

### 5. Modification Examples to Second Embodiment

### 5-1. Modification Example 1

### 5-2. Modification Example 2

### 6. Other Modification Examples

### 7. Conclusion

### 1. Introduction

Before the embodiments of the present disclosure are detailed, a background of the embodiments of the present disclosure is described. As the background of the embodiments, first, an outline of the D2D communication is described, and licensed assisted access (LAA) is briefly described.

### <1-1. Outline of D2D Communication>

In the LTE platform, device-to-device communication (D2D communication) in which terminal devices communicate directly with each other without a base station has been standardized in Release (Rel)-12 of 3GPP. In the Rel-12, particularly, public use cases and commercial use cases are defined as D2D use cases, and in the Rel-12, first, a standard focusing on public use cases are examined. Due to time constraints on standardization, standardization for all use cases has not been completed at the time of Rel-12, and the D2D communication has been standardized in a limited scenario such as an environment of one cell in one public land mobile network (PLMN).

Use cases for the D2D communication using the LTE platform have been discussed in 3GPP SA1 and the like and described as TR 22.803. The description in the TR 22.803 is only for use cases and no specific method for implementation is described therein. Typical use cases that should be implemented in the LTE from TR 22.803 to 3GPP are provided below.

### (Use Case: About Coverage)

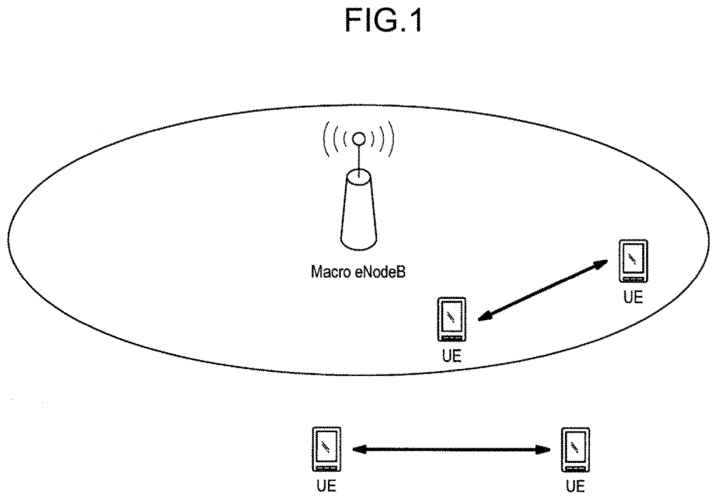

As for a location where a plurality of pieces of user equipment (UE) as terminal devices of the LTE communicates with each other, it is necessary to consider a case where the location is within a coverage range of an evolved node B (eNodeB, also referred to as eNB below) that functions as a base station of the LTE and a case where the location is outside the coverage range thereof. This is because the case where the location is outside the coverage range of the eNB is important for public safety applications. FIG. 1 is an explanatory diagram illustrating the case where the UE is within the coverage range of the eNB and the case where the UE is outside the coverage range thereof. It is also desirable to consider partial coverage, which is communication between the UE within the coverage range of the eNB and the UE outside the coverage range of the eNB.

### (Use Case: D2D Between Different Mobile Network Operators (MNOs))

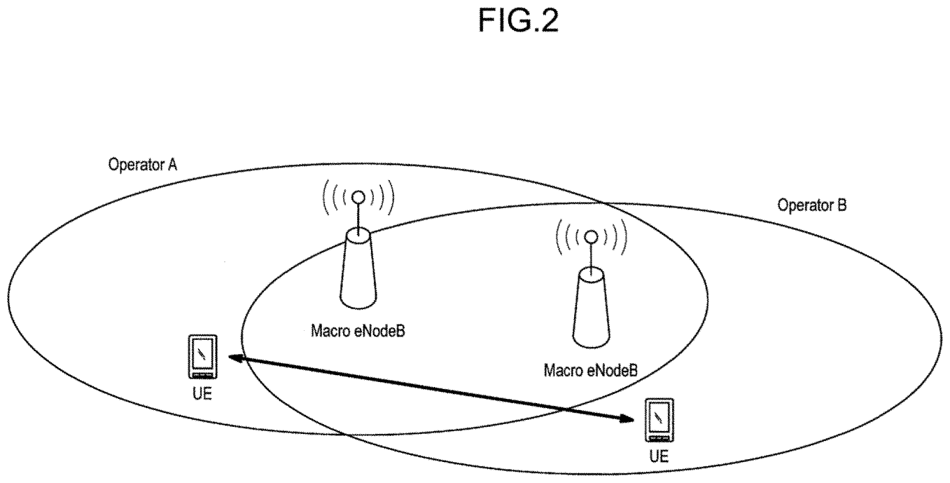

It is also desirable to consider D2D communication between UE belonging to different MNOs. This is because, in the case of public safety applications, the useful usage is impossible if which MNO UE belongs to is distinguished. FIG. 2 is an explanatory diagram illustrating a case where UE belonging to operators A and B respectively, which are different MNOs, perform D2D communication with each other.

It is desirable to implement D2D communication on the LTE system in consideration of the two use cases described above.

Subsequently, the flow for starting D2D communication on the LTE system is described.

### (Flow Until the Start of D2D Communication)

Step 1: Synchronization
Step 2: Discovery (discovery of other terminals)
Step 3: Connection establishment (not required for connection less type communication)
Step 4: D2D communication

In addition, in the D2D communication on the LTE system, the following types of discovery and communication are mainly defined.

### [Discovery]

Type 1: A discovery procedure where resources for discovery signal transmission are allocated on a non UE specific basis
Type 2: A discovery procedure where resources for discovery signal transmission are allocated on a per UE specific basis
Type 2a: Resources are allocated for each specific transmission instance of discovery signal
Type 2b: Resources are semi-persistently allocated for discovery signal transmission

### [Communication]

Mode 1: eNodeB or Rel-10 Relay node schedules the exact resources by a UE to transmit direct data and direct control information
Mode 2: A UE on its own selects resources from resource pool to transmit

In the discovery, resources are classified as either non-UE specific base or UE specific base, and in the UE specific base, resources are further classified as a method of being allocated for every transmission or a method of being semi-statically allocated. The communication is classified into Mode 1 communication in which a manager such as the eNodeB allocates resources, and Mode 2 communication in which resources are selected from a resource pool by itself. In the Mode 2 communication where resources are selected from the resource pool by itself, collisions may occur, so it is contention-based.

### (About Synchronization)

In the case of D2D communication between UE within the coverage range of one eNodeB, if both pieces of the UE use a downlink signal of the eNodeB for synchronization, then both pieces of the UE are also synchronized to some extent.

On the other hand, in the case of D2D communication between UE outside the coverage range of the eNodeB, one of the UE needs to provide a signal for synchronization.

### (About PSS/SSS)

Primary synchronization signal (PSS)/secondary synchronization signal (SSS) is a synchronization signal used in a radio access network between a base station and a UE. The synchronization signal itself for D2D communication on the LTE system is created on the basis of the PSS/SSS.

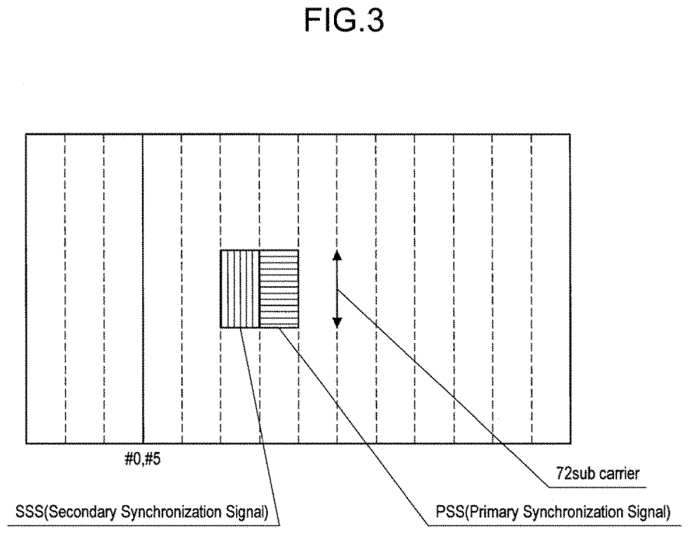

FIG. 3 is an explanatory diagram for explaining the position of the PSS/SSS. As illustrated in FIG. 3, the PSS/SSS is inserted in a subframe #0 and a subframe #5 out of ten subframes #0 to #9 of the LTE. The UE uses the PSS to acquire the timing for each subframe. The UE can also use the SSS to determine the location of the subframe #0.

It is also possible to determine which cell group the PSS is in out of the three cell groups in three types of sequences. The SSS can differentiate 168 types of cells from one another, and 168×2=336 sequences are required to determine the subframe #0. With the PSS and SSS, 168×3=504 different cells can be differentiated from one another.

In the case of D2D communication on the LTE system, in a case where the UE sends a synchronization signal, the PSS/SSS as described above is not always used. However, the UE sends one having a plurality of sequences, although the number is not always 504 in the same manner.

### (About Synchronization Signal in D2D)

The synchronization signal may originate from the base station or may originate from the UE if it is outside the range of the base station. Further, the synchronization signal is sometimes relayed wirelessly. Therefore, the synchronization signal has various attributes.

It is necessary that the UE achieves synchronization using any of the synchronization signals. Examples of possible attributes of the synchronization signal are described below. Specifically, the attributes are whether the synchronization is originated from the eNodeB or the UE, and whether the synchronization is one relayed wirelessly or is a synchronization signal generated originally. In the case of the synchronization relayed wirelessly, the accuracy of the center frequency probably deteriorates. It is thus desirable that the number of relays (the number of hops) is small. Further, the priority of the synchronization signal originated from the eNodeB over the synchronization signal originated from the UE is due to the low accuracy of an oscillator mounted in the UE.

### (About Resources for D2D)

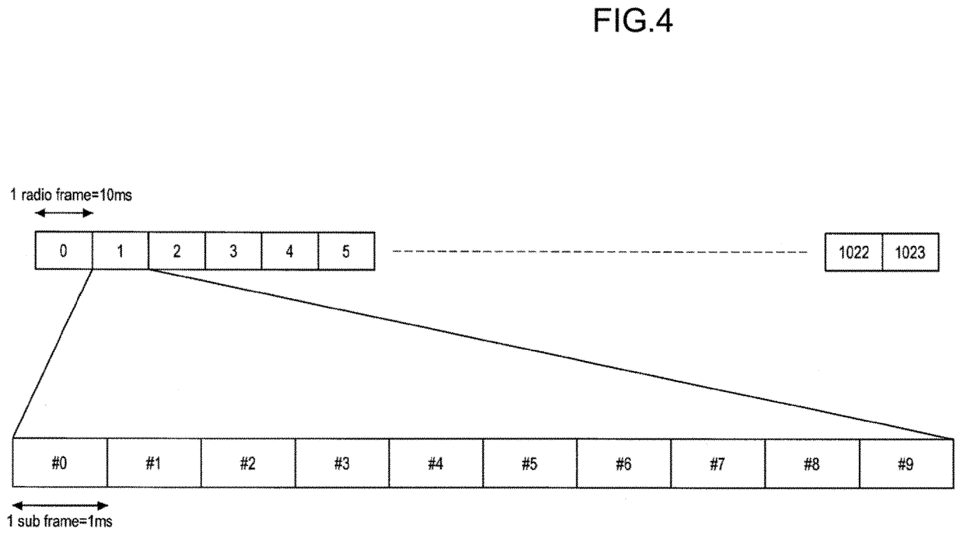

FIG. 4 is an explanatory diagram illustrating the configuration of an LTE resource. In the LTE resource, ten subframes constitute one radio frame, and each radio frame is given a super frame number from 0 to 1023, and the super frame numbers are repeated.

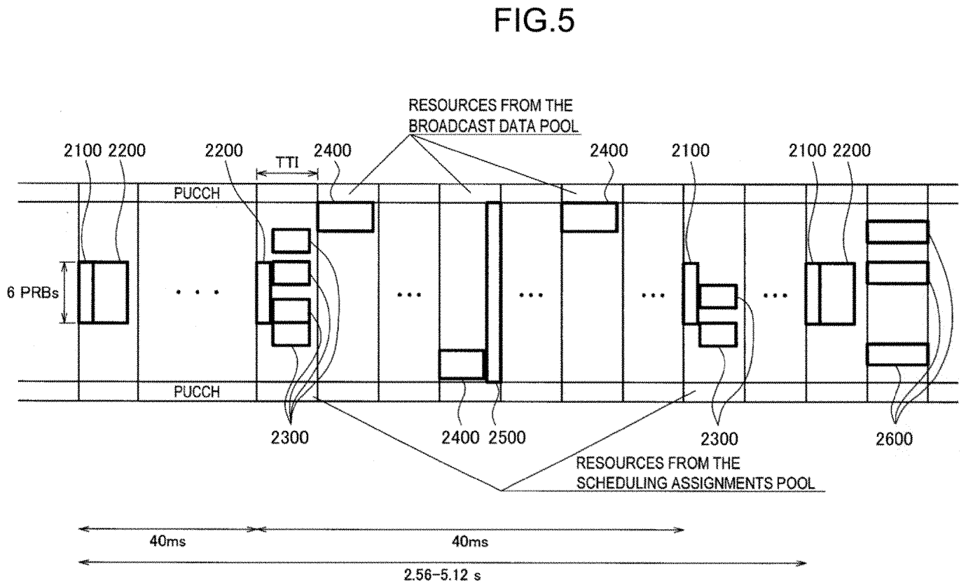

In the D2D communication, some resources in an uplink band are used. In order to designate a resource for D2D communication, an area called a resource pool is prepared. FIG. 5 is an explanatory diagram illustrating a resource pool. In the resource pool illustrated in FIG. 5, a reference numeral 2100 denotes a D2D synchronization signal (D2DSS), a reference numeral 2200 denotes a physical D2D synchronization channel (PD2DSCH), a reference numeral 2300 denotes a scheduling assignment (SA), a reference numeral 2400 denotes D2D data, a reference numeral 2500 denotes a sounding reference signal (SRS) symbol, and a reference numeral 2600 denotes a discovery message.

As the resource pool, the following three types are specified: a scheduling assignment (SA) resource pool; a data resource pool; and a discovery resource pool. In these resource pools, up to four resource pools may be allocated at the same time. Instructions in the resource pool are notified via a system information block (SIB) in the case of being “in coverage”, and, in the case of being “out of coverage”, are notified by specifying information on the resource pool in advance.

There are the following two methods to determine a resource to be used by the UE terminal that actually performs D2D communication from the resource pool: one method in which a managing node (eNB or a relay UE in the future) allocates a resource to each UE and notifies, in the form of schedule allocation, the UE of the resource that the UE may use; and the other method in which the UE selects a resource from the given resource pool to use the resource thus selected. The former is a non-contention-based method because no collisions occur, and the latter is a contention-based method because collisions occur when the same resource is used at the same time.

The communication described above is communication using a so-called licensed band that requires a license. In cellular communication using such a licensed band, there is a concern about depletion of radio resources due to increase in content amount and diversification of the content via radio. To address this, in the cellular communication also, the operation of radio access methods in an unlicensed band and a license shared band is under consideration. In such an unlicensed band, coexistence with other nodes and radio systems is considered important, and radio access methods such as the LTE and an NR are required to have functions of listen before talk (LBT) in which a channel is sensed before transmission and discontinuous transmission. Note that the unlicensed band is, for example, a 2.4 GHz band, a 5 GHz band, and a 6 GHz band. The licensed shared band is, for example, a 3.5 GHz band or a 37 GHz band.

### <1-2. Outline of LAA>

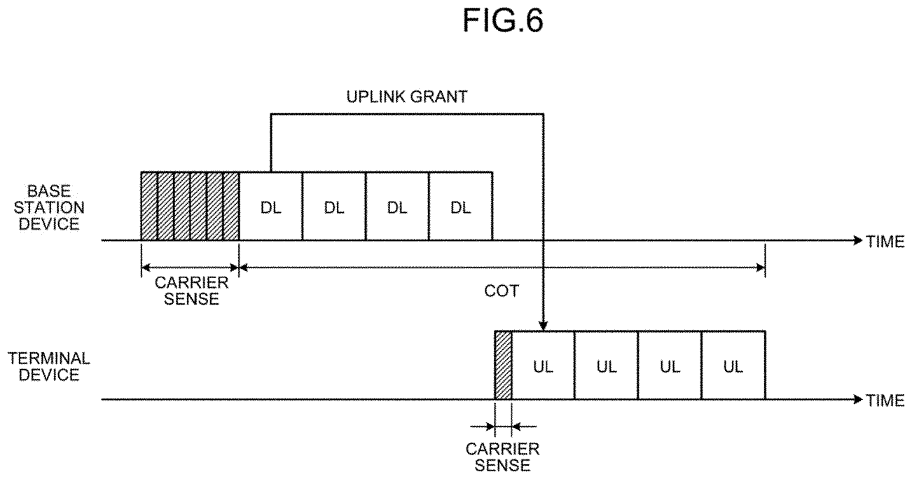

Examples of the radio access methods utilizing an unlicensed band or a licensed shared band include licensed assisted access (LAA). Conventionally, in the licensed assisted access (LAA), a base station (for example, eNB) has acquired an access right to a radio resource (hereinafter, also referred to as a channel). The access right acquired is then shared (in other words, simultaneous usage by multiple users) by the base station and a terminal device (for example, UE) communicating with the base station. This point is described with reference to FIG. 6.

FIG. 6 is a diagram for explaining an example of communication in the LAA. The upper part of FIG. 6 illustrates carrier sense by the base station and a signal sent by the base station. The lower part of FIG. 2 illustrates carrier sense by the terminal device and a signal sent by the terminal device. A square labeled DL is a time resource in which a downlink signal is sent. The time resource is, for example, a slot or a subframe. A square labeled UL is a time resource in which an uplink signal is sent. As illustrated in FIG. 6, the base station first performs carrier sense using random backoff to acquire an access right. Next, the base station sends a downlink signal within a period (channel occupancy time (COT)) in which the channel may be occupied on the basis of the access right acquired. The COT is a period during which the access right acquired is valid. On the other hand, the base station uses an uplink grant to instruct the terminal device to perform an uplink transmission during the COT. The terminal device then performs carrier sense without random backoff, and sends an uplink signal according to the uplink grant.

The method of channel access changes depending on whether or not it is within the COT. Specifically, outside the COT, the communication device performs carrier sense using random backoff to access the channel (LBT category 4, for example). On the other hand, the communication device performs carrier sense without random backoff to access the channel within the COT, that is, during a period when the access right is held (LBT category 2, for example). In the example illustrated in FIG. 6, since the base station does not initially acquire an access right (i.e., outside the COT), the base station uses random backoff to access the channel. On the other hand, the terminal device shares (that is, simultaneous usage by multiple users) the access right acquired by the base station on the basis of the uplink grant, so that the terminal device accesses the channel without random backoff during a period when the access right acquired by the base station is valid (i.e., within the COT). As described above, in the uplink transmission in the LAA, the terminal device does not have to access the channel using random backoff from the beginning because the access right is shared.

However, the LAA is communication between the base station and the terminal device, and the D2D communication using an unlicensed band is still under consideration, and no specific method has been established.

In the conventional sidelink communication, Uulink communication (communication between a base station and a terminal device) is basically performed in the licensed band, and PC5 link (sidelink communication between terminal devices) is also performed in the license band. Further, an ITS band is used in V2X communication (communication for cars such as vehicle-to-vehicle communication), which is a special form of the D2D communication. On the other hand, due to the depletion of radio resources in the licensed band, using an unlicensed band is desirable. It is therefore necessary to define a specific communication method such as control required to implement sidelink communication in an unlicensed band.

Further, the use of an unlicensed band for D2D communication (sidelink communication) has an advantage that D2D communication between different operators is easier to put into practical use, and the establishment of D2D communication technologies using an unlicensed band is desired.

Therefore, in the embodiments of the present disclosure, in view of the technical problems described above, a technology is proposed for realizing efficient use of radio resources by using an unlicensed band in sidelink communication between terminal devices.

### 2. First Embodiment

### <2-1. Outline of First Embodiment>

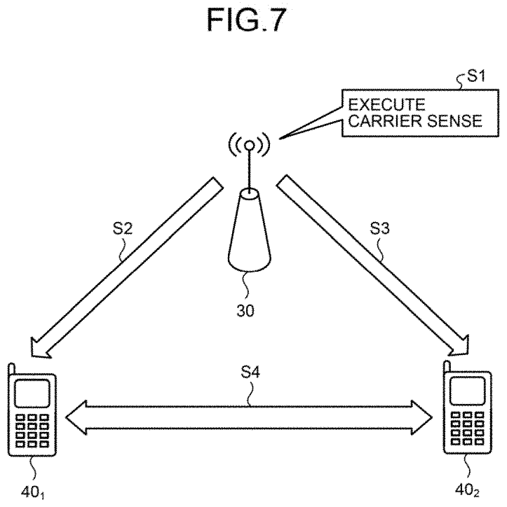

As described above, in the first embodiment of the present disclosure, a technology is proposed which makes it possible to realize efficient use of radio resources by using an unlicensed band in sidelink communication between terminal devices. Such a technology is described with reference to FIG. 7. FIG. 7 is a diagram for explaining an outline of sidelink communication using an unlicensed band according to the first embodiment of the present disclosure.

In the technology of the present disclosure, sidelink communication in the NR, particularly, sidelink communication in an unlicensed band, is described. As illustrated in FIG. 7, an information processing system includes a base station 30 and terminal devices 40₁ and 40₂ that perform sidelink communication.

Basically, a device performing communication (also referred to as a communication device below) such as a base station or a terminal device is required to perform carrier sense before communication in the case of communication using an unlicensed band. In other words, the communication device needs to ascertain the usage of a communication channel before communication so as not to affect communication of other communication devices. For example, in a case where the communication device performs carrier sense and the channel is in a state of not being used (vacant), the communication device can use the channel to send a signal. On the other hand, in a case where the channel is in a state of being used (busy), the communication device waits for the channel to enter the vacant state, and sends a signal.

Generally, a communication device that sends a signal performs carrier sense; however, if the terminal device 40 that sends a signal in sidelink communication performs carrier sense, the processing load on the terminal device 40 increases. Further, if the terminal device 40 performs carrier sense, it may affect communication by another terminal device 40. For example, if a plurality of terminal devices 40 determines that the channel is in the vacant state and sends a signal at the same time, the signals sent may interfere with one another.

In light of the above, in the first embodiment of the present disclosure, a mechanism of sidelink communication is proposed in which the base station 30 performs carrier sense in the sidelink communication of the terminal device 40 to reduce the processing load on the terminal device 40 and reduce the interference of the signals sent.

Specifically, as illustrated in FIG. 7, the base station 30 executes carrier sense in an unlicensed band for the sidelink communication (Step S1), and, on the basis of the result of the carrier sense, notifies the terminal devices 40₁ and 40₂ of control information necessary for the sidelink communication (Steps S2 and S3). The control information includes, for example, information regarding time and frequency resources for signal transmission. The terminal devices 40₁ and 40₂ perform the sidelink communication on the basis of the control information acquired (Step S4).

As a result, in the information processing system according to the first embodiment of the present disclosure, the terminal device 40 can use the unlicensed band to perform the sidelink communication. This enables effective use of radio resources. Further, the base station 30 performs carrier sense, leading to reduction in processing load on the terminal device 40. Further, the base station 30 performs carrier sense, which enables centralized control on the sidelink communication of the terminal device 40, and reduction in interference with other communication due to the sidelink communication.

### <2-2. Configuration of Information Processing System>

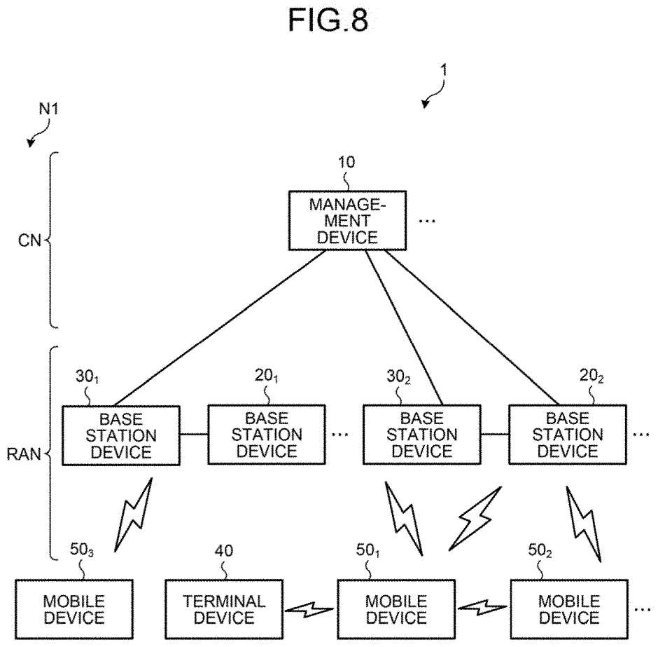

First, an information processing system 1 according to the first embodiment of the present disclosure is described with reference to FIG. 8. FIG. 8 is a diagram illustrating an example of the configuration of the information processing system 1 according to the first embodiment of the present disclosure. The information processing system 1 illustrated in FIG. 8 is a wireless communication system including a plurality of communication devices (mobile devices, terminal devices) capable of sidelink communication.

The information processing system 1 is, for example, a wireless communication system using a radio access technology (RAT) in new radio (NR). The wireless communication system is also called a 5th generation system (5GS). The information processing system 1 is not limited to a mobile phone communication system, and may be, for example, intelligent transport systems (ITS). Further, the information processing system 1 is not limited to a cellular communication system, and may be, for example, another wireless communication system such as a wireless local area network (LAN) system, an aviation wireless system, or a space wireless communication system.

The information processing system 1 may provide a function to execute application processing (for example, edge function) to a mobile device via a wireless network using a radio access technology in the NR. The NR is a type of cellular communication technology, and enables mobile communication of the mobile device by arranging a plurality of areas covered by a base station device in a cell shape.

In the following description, it is assumed that the NR includes a new radio access technology (NRAT) and a further EUTRA (FEUTRA). A single base station may manage a plurality of cells. A cell corresponding to the NR is sometimes referred to as an NR cell.

The NR is the next generation (5th generation) radio access technology (RAT) after the LTE (4th generation communication including LTE-advanced and LTE-advanced pro). The NR is a radio access technology that can support various use cases including an enhanced mobile broadband (eMBB), massive machine type communications (mMTC), and ultra-reliable and low latency communications (URLLC). The NR is under consideration for a technical framework compatible with usage scenarios, requirements, and arrangement scenarios in the use cases.

The NR base station may be called a next generation RAN (NGRAN) node. The NGRAN refers to a RAN (RAN having a reference point with 5GC) in a case where the core network is a 5G core (5GC). That is, the NGRAN may include a gNodeB (gNB) and an ng-eNodeB (ng-eNB). Further, in the NR, the mobile device is sometimes called user equipment (UE).

### [Overall Configuration of Information Processing System]

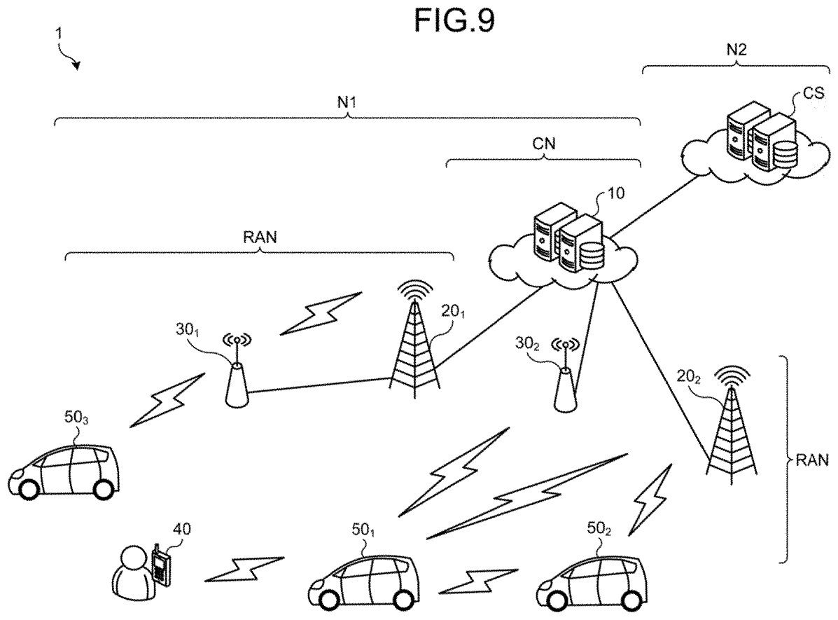

As illustrated in FIG. 8, the information processing system 1 includes a management device 10, the base station device 20, a base station device 30, the terminal device 40, and a mobile device 50. Further, FIG. 9 is a diagram illustrating an example of the specific configuration of the information processing system 1. The information processing system 1 may have a cloud server device CS in addition to the above configuration, but the cloud server device CS does not have to be an essential constituent element.

The plurality of devices of the information processing system 1 constitute a network N1. The network N1 is, for example, a wireless network. The network N1 is, for example, a mobile communication network configured by using a radio access technology such as the NR. The network N1 includes a radio access network RAN and a core network CN.

Note that the devices in the drawing may be considered as devices in a logical sense (logical nodes). Specifically, some of the devices in the drawing may be implemented by a virtual machine (VM), a container, a docker, and the like, and they may be implemented physically on the same hardware.

### [Cloud Server Device]

The cloud server device CS (see FIG. 9) is a processing device (server device, for example) connected to a network N2. For example, the cloud server device CS is a host computer for server that processes a request from a client computer (mobile device 50, for example). The cloud server device CS may be a PC server, a midrange server, or a mainframe server.

Here, the network N2 is a communication network connected to the network N1 via a gateway device (UPF, S-GW, or P-GW, for example). In other words, the network N2 is a data network (DN). Alternatively, for example, the network N2 is a communication network such as the Internet, a regional Internet protocol (IP) network, or a telephone network (fixed telephone network or mobile telephone network, for example). Note that the cloud server device can be rephrased as a server device, a processing device, or an information processing device.

### [Management Device]

The management device 10 (See FIGS. 8 and 9) is a device that manages a wireless network. For example, the management device 10 is a device functioning as an access and mobility management function (AMF). The management device 10 and the gateway device constitute a part of the core network CN. The core network CN is a network of a predetermined entity such as a mobile communication carrier. For example, the core network CN is a 5G core network (5GC). Note that the predetermined entity may be the same as or different from an entity that uses, operates, and/or manages the base station devices 20 and 30.

Note that the management device 10 may have a gateway function. For example, in a case where the core network is the SGC, the management device 10 has a function as a user plane function (UPF). Further, the management device 10 may be an SMF, a PCF, a UDM, or the like. Alternatively, the core network CN may include an SMF, a PCF, a UDM, or the like.

The management device 10 is connected to each of the plurality of base station devices 20 and the plurality of base station devices 30. For example, in the case of the 5GS, there is an N2 reference point between the AMF (10) and the NG-RAN (20, 30), and the AMF (10) and the NG-RAN (20, 30) are logically connected to each other via the NG interface.

The management device 10 may manage communication between the base station device 20 and the base station device 30. For example, the management device 10 manages the position of the mobile device 50 in the network N1 for each mobile device 50 in units of areas (e.g., tracking area, RAN notification area) including a plurality of cells. Note that the management device 10 may ascertain and manage, on a cell-by-cell basis for each mobile device 50, which base station device (or which cell) the mobile device 50 is connected to, of which base station device (or which cell) the mobile device 50 is in the communication area, and so on.

A cell provided by the base station is called a serving cell. The serving cell includes a primary cell (PCell) and a secondary cell (SCell). In a case where dual connectivity (e.g., EUTRA-EUTRA dual connectivity, EUTRA-NR dual connectivity (ENDC), EUTRA-NR dual connectivity with SGC, NR-EUTRA dual connectivity (NEDC), NR-NR dual connectivity) is provided to the UE (e.g., terminal device 40 and mobile device 50), the PCell and the SCell(s) provided by a master node (MN) are called a master cell group. Further, the serving cell may include a primary secondary cell or a primary SCG cell (PSCell). In other words, in a case where the dual connectivity is provided to the UE, the PSCell and the SCell(s) provided by a secondary node (SN) are called a secondary cell group (SCG).

One downlink component carrier and one uplink component carrier may be correlated with one cell. Further, a system bandwidth corresponding to one cell may be divided into a plurality of bandwidth parts. In such a case, one or more bandwidth parts may be set in the UE, and one bandwidth part may be used for the UE as an active BWP. Further, radio resources that can be used by the mobile device 50 (e.g., a frequency band, a numerology (subcarrier spacing), and a slot format (slot configuration)) may be different for each cell, each component carrier, or each BWP.

### [Base Station Device]

The base station device 30 (see FIGS. 8 and 9) is a wireless communication device that performs wireless communication with the terminal device 40 and the mobile device 50. The base station device 30 is a device constituting an infrastructure in D2I (V2I) communication.

The base station device 30 is a kind of the communication device.

As described above, the base station device 30 may be a device equivalent to a wireless base station (base station, node B, eNB, gNB, and the like) or a radio access point (access point). Further or alternatively, in a case where the base station device is an eNB, a gNB, or the like, it may be referred to as 3GPP access. Further or alternatively, in a case where the base station device is a radio access point (access point), it may be referred to as Non-3GPP access. Further or alternatively, the base station device 30 may be a radio relay station (relay node). Further or alternatively, the base station device 30 may be an on-road base station device such as a road side unit (RSU). Further or alternatively, the base station device 30 may be an optical extension device called a remote radio head (RRH). Further or alternatively, in a case where the base station device is a gNB, the base station device may be referred to as a combination of a gNB central unit (CU) and a gNB distributed unit (DU) or any one of them.

The gNB central unit (CU) hosts a plurality of upper layers (e.g. RRC, SDAP, PDCP) of the access stratum for communication with the UE. On the other hand, the gNB-DU hosts a plurality of lower layers (e.g., RLC, MAC, and PHY) of the access stratum. In other words, among message and information described later, RRC signalling may be generated by the gNB CU, while DCI may be generated by the gNB-DU.

In this embodiment, a base station of a wireless communication system is sometimes referred to as a base station device. The base station device 30 may be configured to be able to perform wireless communication with another base station device 20 and the base station device 30. For example, in a case where the plurality of base station devices 20 and 30 are eNBs or a combination of an eNB and a gNB, the devices may be connected by an X2 interface.

Further or alternatively, in a case where the plurality of base station devices 20 and 30 are gNBs or a combination of an eNB and a gNB, the devices may be connected by an Xn interface. Further or alternatively, in a case where the plurality of base station devices 20 and 30 is a combination of a gNB central unit (CU) and a gNB distributed unit (DU), the devices may be connected by an F1 interface. Message and information (information on RRC signalling or DCI) described later may be communicated (e.g., via X2, Xn, F1 interface) between the plurality of base station devices 20 and 30.

Note that the radio access technology used by the base station device 30 may be a cellular communication technology or a wireless LAN technology. Of course, the radio access technology used by the base station device 30 is not limited thereto, and may be another radio access technology. Further, the wireless communication used by the base station device 30 may be radio communication using radio waves or wireless communication (optical wireless) using infrared rays or visible light.

The base station device 20 (see FIGS. 8 and 9) is a wireless communication device that performs wireless communication with the terminal device 40 and the mobile device 50. The base station device 20 is a device constituting a network in D2N (V2N) communication.

The base station device 20 is a kind of the communication device as with the base station device 30. The base station device 20 is a device equivalent to a wireless base station (base station, node B, eNB, gNB, and the like) or a radio access point (access point).

The base station device 20 may be a radio relay station. Further, the base station device 20 may be an optical extension device called a remote radio head (RRH). The base station device 30 may be configured to be able to perform wireless communication with another base station device 30 and the base station device 20.

Note that the radio access technology used by the base station device 20 may be a cellular communication technology or a wireless LAN technology. Of course, the radio access technology used by the base station device 20 is not limited thereto, and may be another radio access technology. Further, the wireless communication used by the base station device 20 may be radio communication using radio waves or wireless communication (optical wireless) using infrared rays or visible light.

Note that the base station devices 20 and 30 may be able to communicate with each other via a base station device-core network interface (NG Interface, S1 Interface, or the like, for example). The interface may be either a wired interface or a wireless interface. Further, the base station devices may be able to communicate with each other via an inter-base station device interface (Xn Interface, X2 Interface, or the like, for example). The interface may be either a wired interface or a wireless interface.

The base station devices 20 and 30 can be used, operated, and/or managed by various entities. For example, the entities are supposed to be a mobile network operator (MNO), a mobile virtual network operator (MVNO), a mobile virtual network enabler (MVNE), a neutral host network (NHN) operator, an enterprise, an educational institution (incorporated educational institution, boards of education of local governments, etc.), a real estate (building, apartment, etc.) administrator, an individual, and the like.

Of course, the entities of use, operation, and/or management of the base station devices 20 and 30 are not limited thereto. The base station devices 20 and 30 may be installed and/or operated by one operator or may be installed and/or operated by an individual.

Of course, the entities of installation and operation of the base station device 20 are not limited thereto. For example, the base station devices 20 and 30 may be installed and operated collaboratively by a plurality of operators or a plurality of individuals. Further, the base station devices 20 and 30 may be shared facilities used by a plurality of operators or a plurality of individuals. In such a case, a third party different from a user may install and/or operate the equipment.

Note that the concept of the base station device includes not only a donor base station but also a relay base station (also referred to as a relay station or a relay station device). Further, the concept of the base station includes not only a structure having a function of the base station but also a device installed in the structure. The structure is, for example, a building such as a tall building, a house, a steel tower, a station facility, an airport facility, a harbor facility, or a stadium. Note that the concept of the structure includes not only a building but also a non-building structure such as a tunnel, a bridge, a dam, a wall, or an iron pole, and equipment such as a crane, a gate, or a windmill. Further, the concept of the structure includes not only a structure on land (on the ground in a narrow sense) or underground, but also a structure on water such as a pier or a mega-float, and an underwater structure such as an oceanographic observation facility. The base station device can be rephrased as a processing device or an information processing device.

The base station devices 20 and 30 may be fixed stations or base station devices configured to be movable (mobile stations). For example, the base station devices 20 and 30 may be devices installed in a mobile object or may be mobile objects themselves. For example, a relay station device having mobility can be regarded as the base station devices 20 and 30 as mobile stations. Further, a mobility device with a function of the base station device (at least a part of the function of the base station device), for example, a vehicle, a drone (aerial vehicle), or a smartphone, also corresponds to the base station devices 20 and 30 as mobile stations.

Here, the mobile object may be a mobile terminal such as a smartphone or a mobile phone. Alternatively, the mobile object may be a mobile object that moves on land (on the ground in a narrow sense) (e.g., vehicle such as an automobile, a bicycle, a bus, a truck, a motorcycle, a train, or a linear motor car) or a mobile object that moves underground (e.g., in the tunnel) (e.g., subway). Alternatively, the mobile object may be a mobile object that moves on the water (e.g., a ship such as a passenger ship, a cargo ship, or a hovercraft) or a mobile object that moves underwater (e.g., a submersible vessel such as a submersible, a submarine, and an unmanned submersible). Alternatively, the mobile object may be a mobile object that moves through the atmosphere (e.g., an aircraft (aerial vehicle) such as an airplane, an airship, and a drone) or a mobile object that moves outside the atmosphere (e.g., an artificial celestial body such as an artificial satellite, a spacecraft, a space station, and a probe).

Further, the base station devices 20 and 30 may be ground base station devices (ground station devices) installed on the ground. For example, the base station devices 20 and 30 may be base station devices placed in a structure on the ground, or may be base station devices installed in a mobile object moving on the ground. More specifically, the base station devices 20 and 30 may be an antenna installed in a structure such as a building and a signal processing device connected to the antenna. Of course, the base station devices 20 and 30 may be structures or mobile objects themselves. The term “ground” is a ground in a broad sense including not only land (ground in a narrow sense) but also underground, on water, and underwater. Note that the base station devices 20 and 30 are not limited to ground base station devices. The base station devices 20 and 30 may be non-ground base station devices (non-ground station devices) capable of floating in the air or space. For example, the base station devices 20 and 30 may be aircraft station devices or satellite station devices.

The aircraft station device is a wireless communication device capable of floating in the atmosphere (including the stratosphere), such as an aircraft. The aircraft station device may be a device mounted on an aircraft or the like, or may be an aircraft itself. Note that the concept of the aircraft includes not only a heavy aircraft such as an airplane and a glider but also a light aircraft such as an air balloon and an airship. Further, the concept of the aircraft includes not only the heavy aircraft and the light aircraft but also a rotorcraft such as a helicopter and an autogyro. Note that the aircraft station device (or, aircraft on which the aircraft station device is mounted) may be an unmanned aircraft such as a drone. Note that the concept of the unmanned aircraft also includes unmanned aircraft systems (UAS) and a tethered UAS. The concept of the unmanned aircraft also includes a lighter than air (LTA) UAS and a heavier than air (HTA) UAS. Other concepts of the unmanned aircraft also include high altitude UAS platforms (HAPs).

The satellite station device is a wireless communication device capable of floating outside the atmosphere. The satellite station device may be a device mounted on a space mobile object such as an artificial satellite, or may be a space mobile object itself. The satellite serving as the satellite station device may be any of a low earth orbiting (LEO) satellite, a medium earth orbiting (MEO) satellite, a geostationary earth orbiting (GEO) satellite, and a highly elliptical orbiting (HEO) satellite. Of course, the satellite station device may be a device mounted on a low earth orbiting satellite, a medium earth orbiting satellite, a geostationary earth orbiting satellite, or a highly elliptical orbiting satellite.

The size of the coverage of the base station devices 20 and 30 may range from a large size such as a macro cell to a small size such as a picocell. Of course, the size of the coverage of the base station devices 20 and 30 may be extremely small such as a femtocell. Further, the base station devices 20 and 30 may have a beamforming capability. In such a case, the base station devices 20 and 30 may form a cell or a service area for each beam.

### [Terminal Device and Mobile Device]

The terminal device 40 is a wireless communication device that performs wireless communication with the base station device 20 or the base station device 30. The terminal device 40 is, for example, a mobile phone, a smart device (smartphone or tablet terminal), a personal digital assistant (PDA), or a personal computer. The mobile device 50 may be a machine-to-machine (M2M) device or an Internet of things (IoT) device (may also called MTC UE, NB-IoT UE, or Cat.M UE).

The terminal device 40 can perform sidelink communication with the mobile device 50 and another terminal device 40. Note that the wireless communication (including sidelink communication) used by the terminal device 40 may be radio communication using radio waves or wireless communication (optical wireless) using infrared rays or visible light.

The mobile device 50 is a mobile wireless communication device that performs wireless communication with the base station device 20 or the base station device 20. The mobile device 50 may be a wireless communication device installed in a mobile object or may be a mobile object itself. For example, the mobile device 50 may be a vehicle that moves on a road, such as an automobile, a bus, a truck, or a motorcycle, or a wireless communication device mounted on the vehicle.

The mobile device 50 can perform sidelink communication with the terminal device 40 and another mobile device 50. For performing sidelink communication, the mobile device 50 can use an automatic retransmission technology such as HARQ. Note that the wireless communication (including sidelink communication) used by the mobile device 50 may be radio communication using radio waves or wireless communication (optical wireless) using infrared rays or visible light.

Note that the “mobile device” is a kind of the communication device, and is also referred to as a mobile station, a mobile station device, a terminal device, or a terminal. The concept of the “mobile device” includes not only a communication device configured to be movable but also a mobile object in which the communication device is installed. In such a case, the mobile object may be a mobile terminal, or may be a mobile object that moves on land (on the ground in a narrow sense), underground, on water, or underwater. Further, the mobile object may be a mobile object that moves through the atmosphere, such as a drone (aerial UE) or a helicopter, or may be a mobile object that moves outside the atmosphere, such as an artificial satellite.

In this embodiment, the concept of the communication device includes not only a portable mobile device (terminal device) such as a mobile terminal but also a device installed in a structure or a mobile object. A structure or a mobile object itself may be regarded as the communication device. Further, the concept of the communication device includes not only a mobile device (terminal device, automobile, etc.) but also a base station device (donor base station, relay base station, etc.). The communication device is a kind of the processing device and the information processing device.

The mobile device 50, the terminal device 40, and the base station devices 20 and 30 are connected to one another through wireless communication (for example, radio waves or optical wireless). In a case where the mobile device 50 moves from a communication area (or cell) of a certain base station device to a communication area (or cell) of another base station device, handover (or handoff) or cell selection (reselection) is performed.

The mobile device 50 and the terminal device 40 may simultaneously connect to a plurality of base station devices or a plurality of cells to perform communication. For example, in a case where one base station device can provide a plurality of cells, the mobile device 50 or the terminal device 40 can perform carrier aggregation by using one cell as the PCell and using another cell as the SCell.

Further, or alternatively, in a case where each base station device can provide one or more cells, the mobile device 50 or the terminal device 40 can execute DC by using one or more cells managed by one base station device (MN (e.g., MeNB or MgNB)) as the PCell or the PCell and the SCell (s) and using one or more cells managed by the other base station device (SN (e.g., SeNB or SgNB)) as the PSCell or the PSCell and the SCell (s). The DC may be referred to as multi connectivity (MC). Alternatively, the mobile device 50, the terminal device 40, and the plurality of base station devices can communicate with one another by a coordinated transmission and reception (coordinated multi-point transmission and reception (CoMP)) technology via cells of different base station devices (a plurality of cells having different cell identifiers or the same cell identifier).

Note that the mobile device 50 and the terminal device 40 are not necessarily devices directly used by a person. The mobile device 50 and the terminal device 40 may be sensors installed in a machine or the like in a factory, such as so-called machine type communication (MTC). Further, the mobile device 50 may be a machine to machine (M2M) device or an Internet of things (IoT) device.

Further, the mobile device 50 and the terminal device 40 may be devices having a relay communication function, as represented by a device to device (D2D) or a vehicle to everything (V2X). Further, the mobile device 50 and the terminal device 40 may be devices called client premises equipment (CPE) used in a wireless backhaul or the like.

Hereinafter, the configuration of the devices constituting the information processing system 1 according to the first embodiment of the present disclosure is specifically described.

### [Configuration of Management Device]

The management device 10 is a device that manages a wireless network. For example, the management device 10 is a device that manages communication of the base station devices 20 and 30. In a case where the core network CN is SGC, the management device 10 may be, for example, a device having a function as the AMF, the SMF, or the UPF.

The management device 10 has a function to execute application processing (edge function, for example), and may function as a server device such as an application server. More specifically, in a case where the UPF is disposed in a local area network (that is, in a case where the UPF is a local UPF), a device for edge computing may be disposed in a DN having an N6 reference point between the DN and the UPF. The device for edge computing may be then included in the management device 10. The device for edge computing may operate as, for example, a multi access edge computing (MEC) platform, an MEC host, and an MEC application.

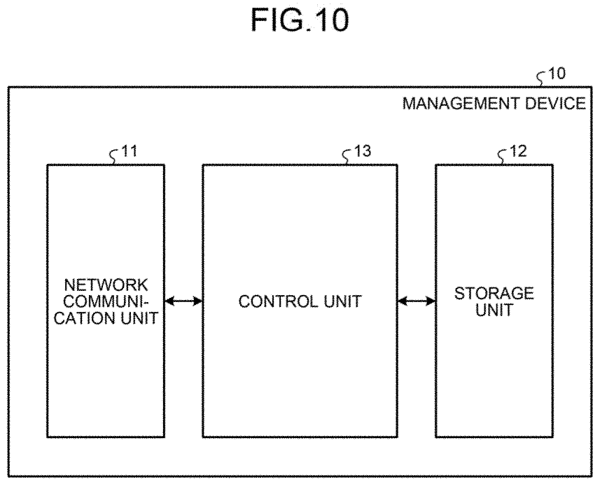

FIG. 10 is a diagram illustrating an example of the configuration of the management device 10 according to the first embodiment of the present disclosure. The management device 10 includes a network communication unit 11, a storage unit 12, and a control unit 13. Note that the configuration illustrated in FIG. 10 is the functional configuration, and the hardware configuration may be different from the functional configuration. Further, the functions of the management device 10 may be distributed and implemented in a plurality of configurations physically separated. For example, the management device 10 may be constituted by a plurality of server devices.

### (Network Communication Unit)

The network communication unit 11 is a communication interface for communicating with other devices. The network communication unit 11 may be a network interface or a device connection interface. The network communication unit 11 has a function to connect to the network N1 directly or indirectly.

For example, the network communication unit 11 may include a local area network (LAN) interface such as a network interface card (NIC), or may include a universal serial bus (USB) interface including a USB host controller and a USB port. Further, the network communication unit 11 may be a wired interface or a wireless interface. The network communication unit 11 functions as a communication means of the management device 10. The network communication unit 11 communicates with the base station devices 20 and 30 under the control of the control unit 13.

### (Storage Unit)

The storage unit 12 is a data readable/writable storage device such as a dynamic random access memory (DRAM), a static random access memory (SRAM), a flash memory, or a hard disk. The storage unit 12 functions as a storage means of the management device 10. The storage unit 12 stores, for example, a connection state of the mobile device 50. For example, the storage unit 12 stores the state of a radio resource control (RRC) and the state of an EPS connection management (ECM) of the mobile device 50. The storage unit 12 may function as a home memory that stores positional information of the mobile device 50.

### (Control Unit)

The control unit 13 is a controller that controls the individual units of the management device 10. The control unit 13 is implemented by, for example, a processor such as a central processing unit (CPU) or a micro processing unit (MPU). For example, the control unit 13 is implemented in response to various programs, stored in the storage device of the management device 10, executed by the processor using a random access memory (RAM) or the like as a work area. Alternatively, the control unit 13 may be implemented, for example, by an integrated circuit such as an application specific integrated circuit (ASIC) or a field programmable gate array (FPGA). Each of the CPU, the MPU, the ASIC, and the FPGA can be regarded as the controller.

### [Configuration of Base Station Device]

Next, the configuration of the base station device 30 is described. The base station device 30 is a wireless communication device that performs wireless communication with the mobile device 50 (or the terminal device 40), and is a communication control device that controls sidelink communication between the mobile devices 50 (or the terminal devices 40). The base station device 30 is, for example, a device that functions as a wireless base station, a radio relay station, a radio access point, or the like. In such a case, the base station device 30 may be an optical extension device such as an RRH. Further, the base station device 30 may be an on-road base station device such as a road side unit (RSU). As described above, the base station device 30 is a device constituting an infrastructure in the D2I (V2I) communication.

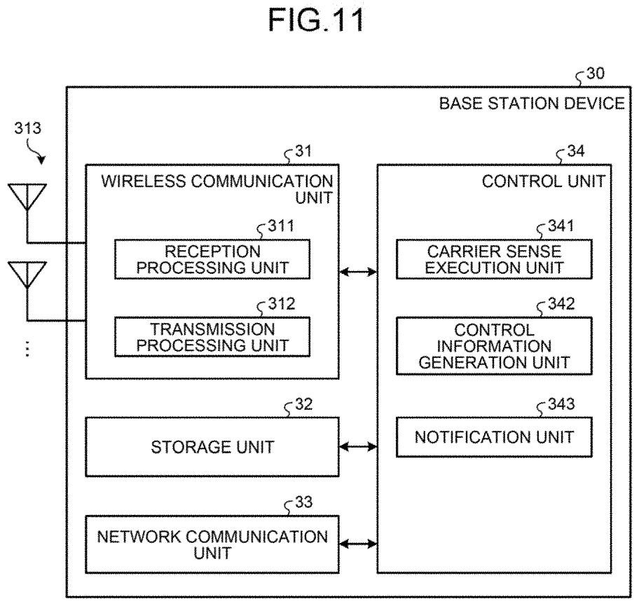

FIG. 11 is a diagram illustrating an example of the configuration of the base station device 30 according to the first embodiment of the present disclosure. As illustrated in FIG. 11, the base station device 30 includes a wireless communication unit 31, a storage unit 32, a network communication unit 33, and a control unit 34. Note that the configuration illustrated in FIG. 11 is the functional configuration, and the hardware configuration may be different from the functional configuration. Further, the functions of the base station device 30 may be distributed and implemented in a plurality of configurations physically separated.

### (Wireless Communication Unit)

The wireless communication unit 31 is a wireless communication interface that performs wireless communication with another wireless communication device (e.g., the mobile device 50, the terminal device 40, the base station device 20, and another base station device 30). The wireless communication unit 31 operates under the control of the control unit 34. Note that the wireless communication unit 31 may support a plurality of radio access methods. For example, the wireless communication unit 31 may support both the NR and the LTE. The wireless communication unit 31 may support W-CDMA or cdma 2000 in addition to the LTE. Of course, the wireless communication unit 31 may support a radio access method other than the NR, the LTE, the W-CDMA, and the cdma 2000.

The wireless communication unit 31 includes a reception processing unit 311, a transmission processing unit 312, and an antenna 313. The wireless communication unit 31 may include a plurality of the reception processing units 311, a plurality of the transmission processing units 312, and a plurality of the antennas 313. In a case where the wireless communication unit 31 supports a plurality of radio access methods, the individual units of the wireless communication unit 31 can be configured separately for each radio access method. For example, the reception processing unit 311 and the transmission processing unit 312 may be configured separately for the LTE and the NR.

The reception processing unit 311 processes an uplink signal received via the antenna 313. For example, the reception processing unit 311 performs signal processing such as orthogonal demodulation, AD conversion, and composite processing on the uplink signal to generate uplink data and uplink control information. The reception processing unit 311 outputs the uplink data and the uplink control information thus generated to the control unit 34.

The transmission processing unit 312 performs transmission processing of downlink control information and downlink data. For example, the transmission processing unit 312 performs signal processing such as encoding processing, DA conversion, and orthogonal modulation on the downlink control information and the downlink data inputted from the control unit 34 to generate a downlink signal. The transmission processing unit 312 sends the generated downlink signal from the antenna 313.

### (Storage Unit)

The storage unit 32 is a data readable/writable storage device such as a DRAM, an SRAM, a flash memory, or a hard disk. The storage unit 32 functions as a storage means of the base station device 30.

### (Network Communication Unit)

The network communication unit 33 is a communication interface for communicating with other devices (e.g., the management device 10, another base station device 30, the base station device 20, and the cloud server device CS). The network communication unit 33 has a function to connect to the network N1 directly or indirectly. For example, the network communication unit 33 includes a LAN interface such as an NIC. Further, the network communication unit 33 may be a wired interface or a wireless interface. The network communication unit 33 functions as a network communication means of the base station device 30. The network communication unit 33 communicates with other devices (e.g., the management device 10, the cloud server device CS, and the like) under the control of the control unit 34. The configuration of the network communication unit 33 may be similar to that of the network communication unit 11 of the management device 10.

### (Control Unit)

The control unit 34 is a controller that controls the individual units of the base station device 30. The control unit 34 is implemented by, for example, a processor (hardware processor) such as a central processing unit (CPU) or a micro processing unit (MPU). For example, the control unit 34 is implemented in response to various programs, stored in the storage device of the base station device 30, executed by the processor using a random access memory (RAM) or the like as a work area. Alternatively, the control unit 34 may be implemented, for example, by an integrated circuit such as an application specific integrated circuit (ASIC) or a field programmable gate array (FPGA). Each of the CPU, the MPU, the ASIC, and the FPGA can be regarded as the controller.

As described above, the control unit 34 controls the individual units of the base station device 30, and here, a case where the control unit 34 controls sidelink communication between the terminal devices 40 is mainly described.

The control unit 34 of the base station device 30 executes carrier sense in an unlicensed band used for the sidelink communication between the terminal devices 40 and generates control information necessary for the sidelink communication. The control unit 34 notifies the terminal device 40 of the control information thus generated to control the sidelink communication of the terminal device 40.

In order to implement the functions described above, as illustrated in FIG. 11, the control unit 34 includes a carrier sense execution unit 341, a control information generation unit 342, and a notification unit 343. The blocks (the carrier sense execution unit 341 to the notification unit 343) of the control unit 34 are functional blocks indicating the functions of the control unit 34. The functional blocks may be software blocks or hardware blocks. For example, each of the functional blocks may be one software module implemented by software (including a microprogram) or one circuit block on a semiconductor chip (die). Of course, each functional block may be a single processor or a single integrated circuit. A method for configuring the functional blocks is arbitrary. Note that the control unit 34 may be configured by functional units different from the functional blocks described above.

The carrier sense execution unit 341 executes carrier sense in an unlicensed band used for the sidelink communication of the terminal device 40. The carrier sense execution unit 341 sets, for example, reception power in a predetermined time/frequency unit as the target for sensing.

Examples of the time unit include a subframe, a slot, and a symbol. That is, the carrier sense execution unit 341 performs carrier sense in units of subframes, slots, or symbols, for example.

Examples of the frequency unit include a resource block (RB), a subchannel, a bandwidth part (BWP), and a component carrier. That is, the carrier sense execution unit 341 performs carrier sense on a resource block or subchannel basis, for example.

Alternatively, the carrier sense execution unit 341 may perform carrier sense in a combination of units of time and units of frequency described above. That is, the carrier sense execution unit 341 performs carrier sense in units of slots of resource blocks, for example.

The carrier sense execution unit 341 measures the reception power in units of time and/or in units of frequency described above. In a case where the measured reception power is smaller than a predetermined threshold, the carrier sense execution unit 341 determines that the time or frequency at which the sensing has been executed is in a vacant state. On the other hand, in a case where the measured reception power is equal to or greater than the predetermined threshold, the carrier sense execution unit 341 determines that the time or frequency at which the sensing has been executed is in a busy state.

The carrier sense execution unit 341 measures, for example, reference signal received power (RSRP) as the reception power. Alternatively, the carrier sense execution unit 341 may measure a reference signal strength indicator (RSSI) or a reference signal received quality (RSRQ) as the reception power.

Further or alternatively, the carrier sense execution unit 341 may measure a channel busy ratio (CBR) or an occupancy time of a resource.

The control information generation unit 342 generates control information on the basis of a result of the carrier sense by the carrier sense execution unit 341. The control information includes at least one piece of information related to (1) through (4) below. Note that the control information may include information other than (1) through (4) below.
(1) Time and frequency resources for transmission of sidelink communication in unlicensed band
(2) Time and frequency resources for report/feedback of sidelink communication
(3) Time and frequency resources for retransmission of sidelink communication in unlicensed band
(4) Transmission power

For example, the information regarding (1) includes information on time and frequency resources for sending a physical sidelink control channel (PSCCH) and a physical sidelink shared channel (PSSCH).

Further, the information regarding (2) includes, for example, at least one of time and frequency resources for hybrid ACK (HARQ) feedback of sidelink communication, time and frequency resources for CSI reporting, and time and frequency resources for measurement report.

Further, the information regarding (3) includes, for example, information on time and frequency resources for blind retransmission and time and frequency resources for HARQ-based retransmission.

As described above, the information processing system 1 of the present disclosure is a wireless communication system using the NR radio access technology. In the NR, for example, in communication in an unlicensed band, it is assumed that communication is periodically performed using the same frequency resource (for example, a channel or a subcarrier). Further, for example, it is assumed that the terminal device 40 performs communication using a specific symbol (n symbol from the top, for example) among a plurality of symbols of a subframe. Alternatively, the terminal device 40 may perform communication using a specific symbol of the resource block. Note that the communication by the terminal device 40 includes communication with the base station devices 20 and 30 and sidelink communication with another terminal device 40.

As described above, the technology of the present disclosure focuses on the fact that the terminal device 40 performs communication in a predetermined cycle on the time axis, and allocates a resource in the time axis direction to the sidelink communication of the terminal device 40. Specifically, the control information generation unit 342 estimates a resource that can be used for communication in the time axis direction on the basis of a result of the sensing by the carrier sense execution unit 341. For example, in a case where the carrier sense execution unit 341 determines that n symbol from the top among a plurality of symbols of the subframe is in a busy state, the control information generation unit 342 determines that symbols other than the n symbol from the top, among the plurality of symbols of the subframe, are in a vacant state. The control information generation unit 342 allocates the symbol that has been determined to be in the vacant state to the sidelink communication of the terminal device 40.

Note that, instead of the control information generation unit 342, the carrier sense execution unit 341 may determine the vacant state using the symbol that is in the busy state.

Further, the control information generation unit 342 may determine the vacant state of the radio resource on the basis of, for example, information regarding a resource included in a control signal used for communication of the terminal device 40. For example, in a case where the control signal includes reservation information of a resource used for communication of the terminal device 40, the control information generation unit 342 may determine the busy state or the vacant state of the radio resource on the basis of the reservation information. Alternatively, the carrier sense execution unit 341 may perform the determination.

In addition, the control information generation unit 342 generates control information for each of a plurality of kinds of sidelink communication. Specifically, the control information generation unit 342 generates control information for each set of the terminal devices 40 that perform sidelink communication. As described above, the control information generation unit 342 generates control information for every sidelink communication, which makes it possible to avoid signal collision in each of a plurality of kinds of sidelink communication.

The notification unit 343 notifies the terminal device 40 of the control information generated by the control information generation unit 342. The notification unit 343 may notify the control information dynamically or in a semi-persistent manner. In a case where notifying the control information in a semi-persistent manner, the notification unit 343 notifies the terminal device 40 of, for example, control information including an available start time and end time. Note that the available start time and end time are set by the control information generation unit 342 on the basis of a result of the sensing by the carrier sense execution unit 341, for example.

Alternatively, the notification unit 343 may notify the control information including the time of validity of the control information instead of the end time. Further, the notification unit 343 may notify the control information in a semi-persistent manner by notifying the terminal device 40 of activation/release of the use of the control information as one bit of information, for example.

The notification unit 343 notifies the terminal device 40 of the control information using, for example,
(1) through (6) below.
(1) Radio resource control (RRC)
(2) System information block (SIB)
(3) Downlink control information (DCI)
(4) Physical broadcast channel (PBCH)
(5) Physical downlink control channel (PDCCH)
(6) Physical downlink shared channel (PDSCH)

### [Configuration of Terminal Device]

Next, the configuration of the terminal device 40 is described. The terminal device 40 is a wireless communication device. For example, the terminal device 40 may be user equipment (UE) such as a mobile phone or a smart device. The terminal device 40 can perform wireless communication with the base station device 20 and the base station device 30. Further, the terminal device 40 can perform sidelink communication with the mobile device 50 and another terminal device 40.

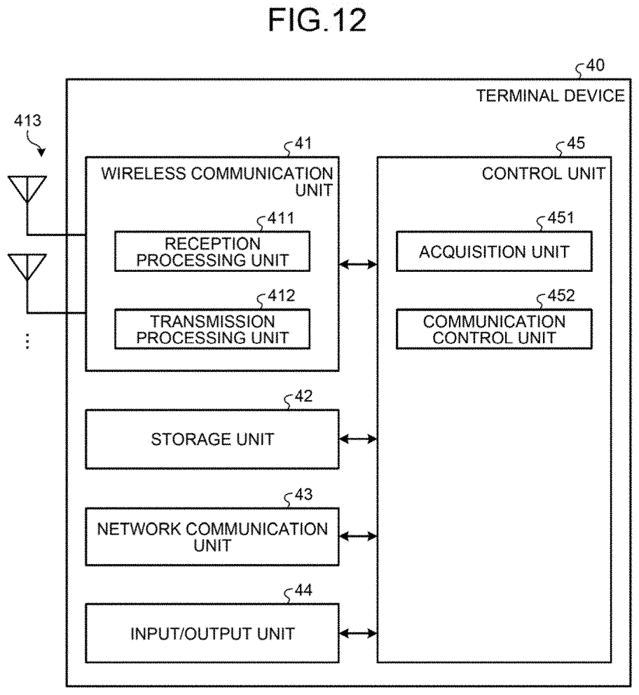

FIG. 12 is a diagram illustrating an example of the configuration of the terminal device 40 according to the first embodiment of the present disclosure. The terminal device 40 includes a wireless communication unit 41, a storage unit 42, a network communication unit 43, an input/output unit 44, and a control unit 45. Note that the configuration illustrated in FIG. 12 is the functional configuration, and the hardware configuration may be different from the functional configuration. Further, the functions of the terminal device 40 may be distributed and implemented in a plurality of configurations physically separated. Further, in the configuration of the terminal device 40, the network communication unit 43 and the input/output unit 44 do not have to be essential constituent elements.

### (Wireless Communication Unit)

The wireless communication unit 41 is a wireless communication interface that performs wireless communication with other wireless communication devices (e.g., the base station devices 20 and 30, another terminal device 40, and the mobile device 50). The wireless communication unit 41 operates under the control of the control unit 45. The wireless communication unit 41 supports one or more radio access methods. For example, the wireless communication unit 41 supports both the NR and the LTE. The wireless communication unit 41 may support the W-CDMA or the cdma 2000 in addition to the NR or the LTE. Further, the wireless communication unit 41 may support communication using NOMA.

The wireless communication unit 41 includes a reception processing unit 411, a transmission processing unit 412, and an antenna 413. The wireless communication unit 41 may include a plurality of the reception processing units 411, a plurality of the transmission processing units 412, and a plurality of the antennas 413. In a case where the wireless communication unit 41 supports a plurality of radio access methods, the individual units of the wireless communication unit 41 can be configured separately for each radio access method. For example, the reception processing unit 411 and the transmission processing unit 412 may be configured separately for the LTE and the NR.

The reception processing unit 411 processes a downlink signal received via the antenna 413. For example, the reception processing unit 411 performs signal processing such as orthogonal demodulation, AD conversion, and composite processing on the downlink signal to generate downlink data and downlink control information. The reception processing unit 411 outputs the downlink data and the downlink control information thus generated to the control unit 45.

The transmission processing unit 412 performs transmission processing of uplink control information and uplink data. For example, the transmission processing unit 412 performs signal processing such as encoding processing, DA conversion, and orthogonal modulation on the uplink control information and the uplink data inputted from the control unit 45 to generate an uplink signal. The transmission processing unit 412 sends the generated uplink signal from the antenna 413.

### (Storage Unit)

The storage unit 42 is a data readable/writable storage device such as a DRAM, an SRAM, a flash memory, or a hard disk. The storage unit 42 functions as a storage means of the terminal device 40.

### (Network Communication Unit)

The network communication unit 43 is a communication interface for communicating with other devices. For example, the network communication unit 43 is a LAN interface such as an NIC. The network communication unit 43 has a function to connect to the network N1 directly or indirectly. The network communication unit 43 may be a wired interface or a wireless interface. The network communication unit 43 functions as a network communication means of the terminal device 40. The network communication unit 43 communicates with other devices under the control of the control unit 45.

### (Input/output Unit)

The input/output unit 44 is a user interface for sending/receiving information to/from a user. For example, the input/output unit 44 is an operation device for the user to perform various operations, such as a keyboard, a mouse, an operation key, and a touch panel. Alternatively, the input/output unit 44 is a display device such as a liquid crystal display or an organic electroluminescence display. The input/output unit 44 may be an acoustic device such as a speaker or a buzzer. The input/output unit 44 may be a lighting device such as a light emitting diode (LED) lamp. The input/output unit 44 functions as an input/output means (input means, output means, operation means, or notification means) of the terminal device 40.

### (Control Unit)

The control unit 45 is a controller that controls the individual units of the terminal device 40. The control unit 45 is implemented by, for example, a processor (hardware processor) such as a central processing unit (CPU) or a micro processing unit (MPU). For example, the control unit 45 is implemented in response to various programs, stored in the storage device of the terminal device 40, executed by the processor using a random access memory (RAM) or the like as a work area. Alternatively, the control unit 45 may be implemented, for example, by an integrated circuit such as an application specific integrated circuit (ASIC) or a field programmable gate array (FPGA). Each of the CPU, the MPU, the ASIC, and the FPGA can be regarded as the controller.

As described above, the control unit 45 controls the individual units of the terminal device 40, and here, a case where the control unit 45 performs sidelink communication using an unlicensed band is mainly described.

As illustrated in FIG. 12, the control unit 45 includes an acquisition unit 451 and a communication control unit 452. The blocks (the acquisition unit 451 and the communication control unit 452) of the control unit 45 are functional blocks indicating the functions of the control unit 45. The functional blocks may be software blocks or hardware blocks. For example, each of the functional blocks may be one software module implemented by software (including a microprogram) or one circuit block on a semiconductor chip (die). Of course, each functional block may be a single processor or a single integrated circuit. A method for configuring the functional blocks is arbitrary. Note that the control unit 45 may be configured by functional units different from the functional blocks described above.

The acquisition unit 451 acquires control information from the base station device 30. In a case where performing sidelink communication in an unlicensed band, the acquisition unit 451 acquires, for example, control information periodically notified by the base station device 30. Alternatively, in a case where performing sidelink communication in an unlicensed band, the acquisition unit 451 may send a carrier sense request to cause the base station device 30 to execute carrier sense for example, and acquire the control information.

The communication control unit 452 executes sidelink communication in an unlicensed band on the basis of the control information acquired by the acquisition unit 451. For example, in a case where data is sent to the terminal device 40 which is the other end of the communication, the communication control unit 452 sends the data by using time and frequency resources included in the control information. On the other hand, in a case where data is received from the other end of the communication, the communication control unit 452 may wait for the data in the time and frequency resources included in the control information. This allows the terminal device 40 to wait for data at a necessary time and frequency, leading to reduction in unnecessary power consumption.

### <2-3. Flow of Sidelink Communication Processing>

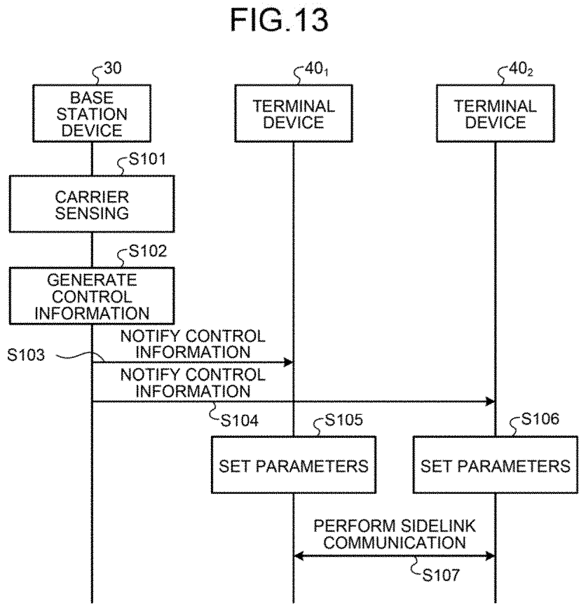

Next, the flow of sidelink communication processing using a beam by the information processing system 1 is described with reference to FIG. 13. FIG. 13 is a sequence diagram for explaining the flow of sidelink communication processing according to the first embodiment of the present disclosure.

As illustrated in FIG. 13, the base station device 30 performs carrier sensing of an unlicensed band (Step S101). The base station device 30 generates control information on the basis of the result of carrier sensing (Step S102) and notifies the terminal devices 40₁ and 40₂ of the control information generated (Steps S103 and S104).

The terminal devices 40₁ and 40₂ set, on the basis of the control information acquired, parameters necessary for sidelink communication using time and frequency resources included in the control information, for example (Steps S105 and S106). The terminal devices 40₁ and 40₂ perform the sidelink communication using the parameters set (Step S107).

### 3. Modification Examples to First Embodiment

### <3-1. Modification Example 1>

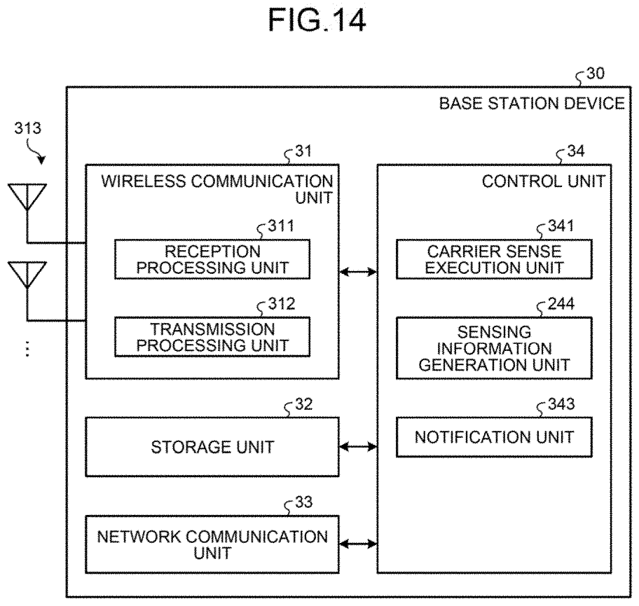

Next, the modification example 1 to the information processing system 1 according to the first embodiment of the present disclosure is described with reference to FIGS. 14 to 16. In this modification example, the base station device 30 does not designate time and frequency resources for sidelink communication, but designates a range of time and frequency resources therefor (or constraints on the terminal device 40 to execute carrier sense). Then, the terminal device 40 executes carrier sense in the designated range and performs sidelink communication.

For example, as the number of terminal devices 40 that perform sidelink communication in an unlicensed band increases, a load on the base station device 30 that controls such sidelink communication increases. To address this, in the present modification example, the base station device 30 sets constraints on time and frequency resources to be used for sidelink communication, and the terminal device 40 determines time and frequency resources to be actually used for sidelink communication, which reduces the processing load on the base station device 30.

FIG. 14 is a diagram illustrating an example of the configuration of the base station device 30 according to the modification example 1 to the first embodiment of the present disclosure. The base station device 30 illustrated in FIG. 14 has a functional configuration similar to that of the base station device 30 illustrated in FIG. 11 except that a sensing information generation unit 244 is included instead of the control information generation unit 342.

The sensing information generation unit 244 generates sensing information including constraints on sensing instead of the control information. The sensing information includes information on a range (constraints) for sensing, for example, information on time and frequency at which the terminal device 40 executes carrier sense, and information on maximum transmission power.

Specifically, the information on time at which carrier sense is executed includes, for example, a start time, an end time, and an execution period on a time axis of the carrier sensing by the terminal device 40. Further, the information on such time includes sensible units of time axis (for example, seconds, milliseconds, subframes, slots, or symbols).

As described above, it is possible that communication of the terminal device 40 is periodically performed using the same symbol of a subframe or a resource block. Therefore, the sensing information generation unit 244 designates, for example, a range within which sensing is performed except for a symbol that has been detected to be in a busy state by the carrier sense execution unit 341. For example, in a case where n symbol from the top of a subframe including N symbol is in a busy state, the sensing information generation unit 244 generates sensing information with the sensing range from n+1 symbol to N symbol excluding the n symbol from the top.

Further, the information on frequency at which carrier sense is executed includes, for example, a start frequency, an end frequency, and the number of frequency units of a frequency axis of carrier sensing by the terminal device 40. Further, the information on such frequency includes sensible units of the frequency axis (physical resource block (PRB), subchannel, BPW, component carrier).

For example, in a case where the unlicensed band is a frequency band of a wireless LAN system, the frequency band of the unlicensed band is, for example, a 2.4 GHz band or a 5 GHz band. In such a case, the sensing information generation unit 244 generates sensing information with a band having a low channel congestion level as the sensing range, for example, among the 2.4 GHz band and the 5 GHz band. Alternatively, the sensing information may be generated with at least one channel included in a predetermined band as a sensing range.

As described above, the sensing information generation unit 244 determines the range in which the terminal device 40 performs sensing, which eliminates the need to allocate a resource to the terminal device 40 for every sidelink communication, leading to reduction in processing load on the base station device 30.

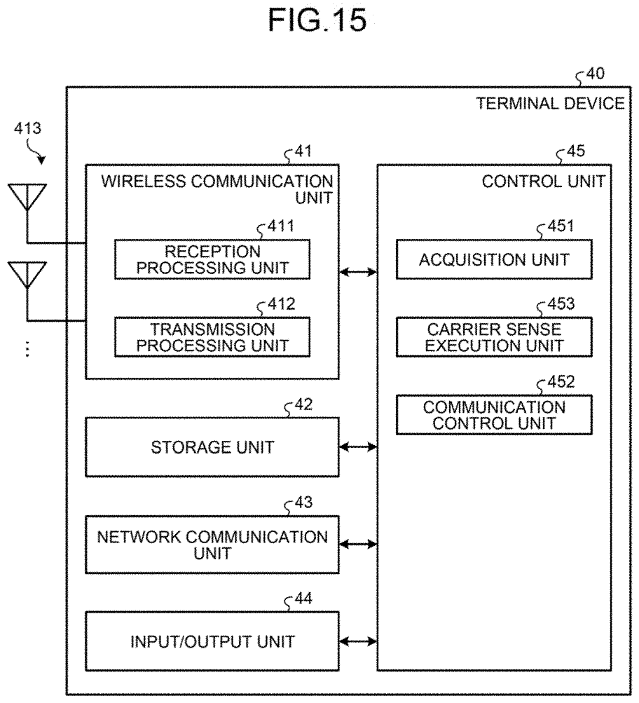

FIG. 15 is a diagram illustrating an example of the configuration of the terminal device 40 according to the modification example 1 to the first embodiment of the present disclosure. The terminal device 40 illustrated in FIG. 15 has a functional configuration similar to that of the terminal device 40 illustrated in FIG. 12 except that a carrier sense execution unit 453 is further included.

The acquisition unit 451 illustrated in FIG. 15 acquires sensing information instead of control information. The carrier sense execution unit 453 executes carrier sense on the basis of the sensing information.

Specifically, the carrier sense execution unit 453 measures the reception power in a range of time and frequency included in the sensing information, and executes carrier sense.

The communication control unit 452 sets parameters necessary for sidelink communication according to the result of the carrier sense by the carrier sense execution unit 453, and performs sidelink communication with the terminal device 40 which is the other end of the communication. The communication control unit 452 sets, for example, parameters related to time and frequency resources for transmission and/or retransmission. Further, the communication control unit 452 sets parameters related to time and frequency resources for HARQ feedback transmission. The communication control unit 452 sets the transmission power within a range not exceeding the maximum transmission power included in the sensing information.

As described above, the carrier sense execution unit 453 of the terminal device 40 performs carrier sense before the sidelink communication, which enables the terminal device 40 to perform the sidelink communication while avoiding collisions with other communication. Further, since the carrier sense execution unit 453 executes carrier sense within a predetermined range on the basis of the sensing information, a processing load on carrier sense by the terminal device 40 can be reduced.

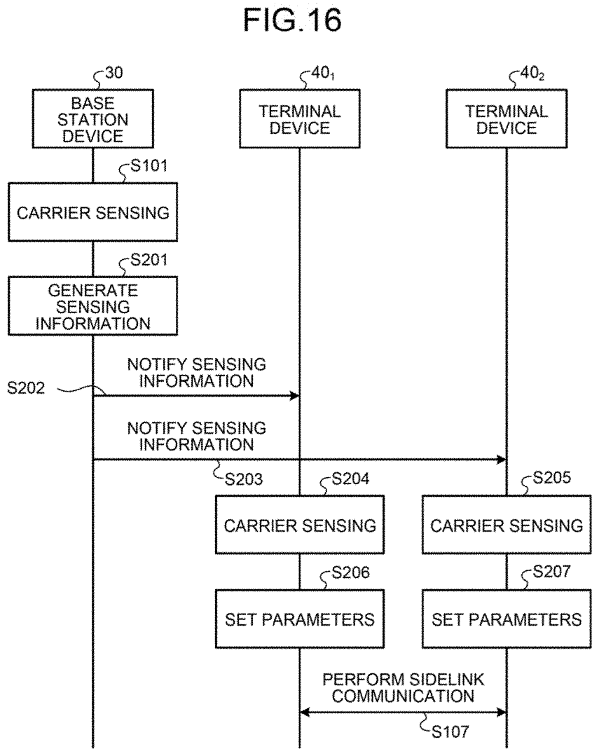

FIG. 16 is a sequence diagram for explaining the flow of sidelink communication processing according to the modification example 1 to the first embodiment of the present disclosure. Note that the same processing as that of the sidelink communication processing illustrated in FIG. 13 is denoted by the same reference numeral, and the description thereof is omitted.

The base station device 30 generates sensing information on the basis of the result of carrier sensing (Step S201). The base station device 30 notifies the terminal devices 40₁ and 40₂ of the sensing information generated (Steps S202 and S203).

The terminal devices 40₁ and 40₂ perform carrier sensing within a range included in the sensing information (Steps S204 and S205). The terminal devices 40₁ and 40₂ set parameters necessary for sidelink communication on the basis of the results of sensing in Steps S204 and S205 (Steps S206 and S207). The terminal devices 40₁ and 40₂ perform the sidelink communication using the parameters set (Step S107).

### <3-2. Modification Example 2>

In the first embodiment and the modification example 1 to the first embodiment described above, it is assumed that the terminal devices 40₁ and 40₂ performing sidelink communication are within the coverage (in coverage) of the cell of the base station device 30. Therefore, in a case where one of the terminal devices 40₁ and 40₂ is outside the coverage of the cell of the base station device 30 (partial coverage), the terminal device outside the coverage cannot receive the control information and the like from the base station device 30.

In such a case, in this modification example, a terminal device within the coverage (here, the terminal device 40₁ for example) relays control information or the like notified by the base station device 30 to a terminal device outside the coverage (here, the terminal device 40₂ for example). This allows the terminal device 40₂ outside the coverage of the base station device 30 to acquire information necessary for setting a beam, and allows the terminal devices 40₁ and 40₂ to perform sidelink communication using the beam. Note that, similarly, data to be notified to the base station device 30 by the terminal device 40₂ may also be relayed through the terminal device 40₁ and notified to the base station device 30.

Note that, here, the device that relays data between the terminal device 40₂ and the base station device 30 is the terminal device 40₁; however, the present disclosure is not limited thereto, and for example, a terminal device 40 other than the terminal device 40₁, the mobile device 50, or a base station device other than the base station device 30 may relay data.

In addition, in a case where both of the terminal devices 40₁ and 40₂ are outside the coverage, neither the terminal devices 40₁ nor 40₂ can acquire the control information from the base station device 30. In such a case, for example, the base station device 30 designates a terminal device 40 capable of communicating with at least one of the terminal devices 40₁ and 40₂ as the master terminal, which allows the terminal devices 40₁ and 40₂ to perform sidelink communication on the basis of the control information. Control of sidelink communication by the master terminal is described in the second embodiment.

Alternatively, in a case where the base station device 30 determines that both of the terminal devices 40₁ and 40₂ are about to be outside the coverage, the base station device 30 may notify, in advance, the terminal devices 40₁ and 40₂ of control information to be used if the terminal devices 40₁ and 40₂ are outside the coverage. Alternatively, in a case where the terminal devices 40₁ and 40₂ are outside the coverage, the sidelink communication may continue on the basis of the control information that has been used right before. In such a case, the possibility of collision due to the sidelink communication increases; however, the terminal devices 40₁ and 40₂ can continue the sidelink communication even if the terminal devices 40₁ and 40₂ are outside the coverage of the base station device 30.

### 4. Second Embodiment

### <4-1. Outline of Second Embodiment>

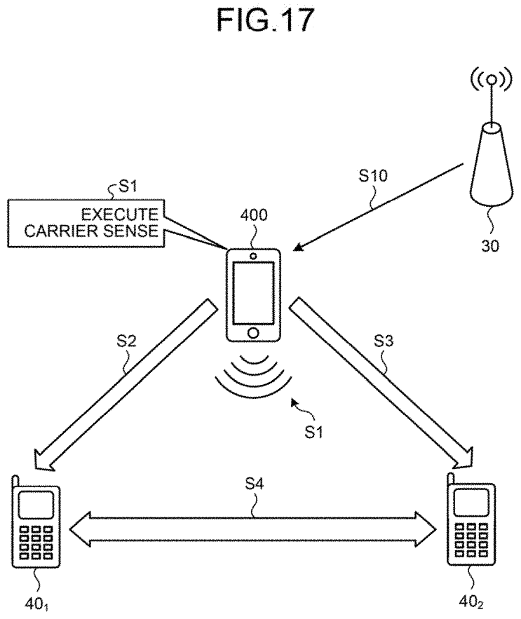

FIG. 17 is a diagram for explaining the outline of sidelink communication according to the second embodiment of the present disclosure. In an information processing system according to the second embodiment of the present disclosure, the base station device 30 does not control the sidelink communication, and a terminal device (hereinafter, also referred to as a master terminal) 400 to which the base station device 30 gives the authorization related to control of the sidelink communication controls the sidelink communication.

As illustrated in FIG. 17, the information processing system includes the base station device 30, the master terminal 400, and the terminal devices 40₁ and 40₂ that perform sidelink communication. In the second embodiment of the present disclosure, the master terminal 400 controls the sidelink communication of the terminal device 40.

As illustrated in FIG. 17, the base station device 30 designates the terminal device 400 as a master terminal that controls the sidelink communication between the terminal devices 40₁ and 40₂ (Step S10). Note that the method for controlling the sidelink communication by the master terminal 400 is the same as the control method by the base station 30 illustrated in FIG. 7, and thus the description thereof is omitted.

### <4-2. Configuration of Information Processing System>

### [Configuration of Base Station Device]

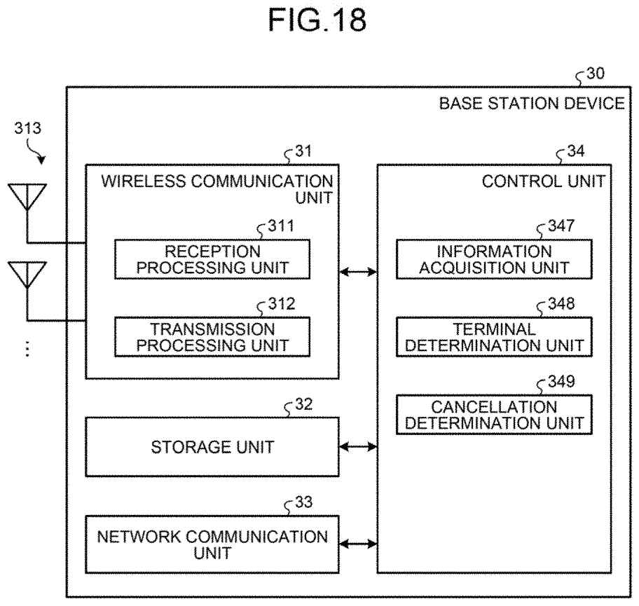

Next, FIG. 18 is a diagram illustrating an example of the configuration of the base station device 30 according to the second embodiment of the present disclosure. In the base station device 30 illustrated in FIG. 18, the control unit 34 includes an information acquisition unit 347, a terminal determination unit 348, and a cancellation determination unit 349 instead of the carrier sense execution unit 341 through the notification unit 343.

The information acquisition unit 347 acquires information necessary to determine the master terminal 400 from the terminal device 40. The information acquisition unit 347 acquires, for example, information regarding capability from the terminal device 40. Alternatively, the information acquisition unit 347 may acquire positional information of the terminal device 40.

The terminal determination unit 348 determines the master terminal 400 on the basis of the information acquired by the information acquisition unit 347. For example, the terminal determination unit 348 determines that the terminal device 40 near the terminal devices 40₁ and 40₂ performing sidelink communication is the master terminal 400 on the basis of the positional information of the terminal device 40 acquired by the information acquisition unit 347. The terminal determination unit 348 sends an authorization notification that gives authorization to the master terminal 400 determined via the wireless communication unit 31.

For example, the terminal determination unit 348 gives authorization by indicating the procedure or parameters of the master terminal 400 determined. The terminal determination unit 348 performs such an indication using, for example, the RRC, the SIB, downlink control information (DCI), the PDCCH, the PDSCH, or the like.

The cancellation determination unit 349 determines cancellation of the authorization that has been given to the master terminal 400. The cancellation determination unit 349 determines cancellation of the authorization on the basis of, for example, the capability and the positional information of the master terminal 400.

Alternatively, the cancellation determination unit 349 may determine cancellation of the authorization according to a request for cancellation from the master terminal 400 or the communication status of the terminal device 40.

For example, the cancellation determination unit 349 cancels the authorization of the master terminal 400 in a case where it is determined that the quality of communication by the terminal device 40 other than the terminal devices 40₁ and 40₂ deteriorates due to control of the sidelink communication by the master terminal 400.

Note that the cancellation determination unit 349 determines whether or not the quality of the communication by the terminal device 40 other than the terminal devices 40₁ and 40₂ deteriorates according to a report from that terminal device 40.

Alternatively, the cancellation determination unit 349 may cancel the authorization of the master terminal 400 in a case where it is determined that at least one of the terminal devices 40₁ and 40₂ is outside the coverage of the master terminal 400. The cancellation determination unit 349 makes such a determination, for example, on the basis of the positional information of the terminal devices 40₁ and 40₂ and the master terminal 400. Alternatively, the cancellation determination unit 349 may make such a determination on the basis of a notification from the master terminal 400 or the terminal devices 40₁ and 40₂.

The cancellation determination unit 349 sends, via the wireless communication unit 31, a cancellation notification to the master terminal 400 determined to be canceled. The terminal determination unit 348 sends the cancellation notification using, for example, the RRC, the SIB, downlink control information (DCI), the PDCCH, the PDSCH, or the like.

Note that, for example, in a case where the terminal determination unit 348 sets a validity period during which authorization is given to the master terminal 400, an expiry date is added to the authorization notification, which may omit the determination of cancellation and transmission of the cancellation notification by the cancellation determination unit 349.

### [Configuration of Master Terminal]

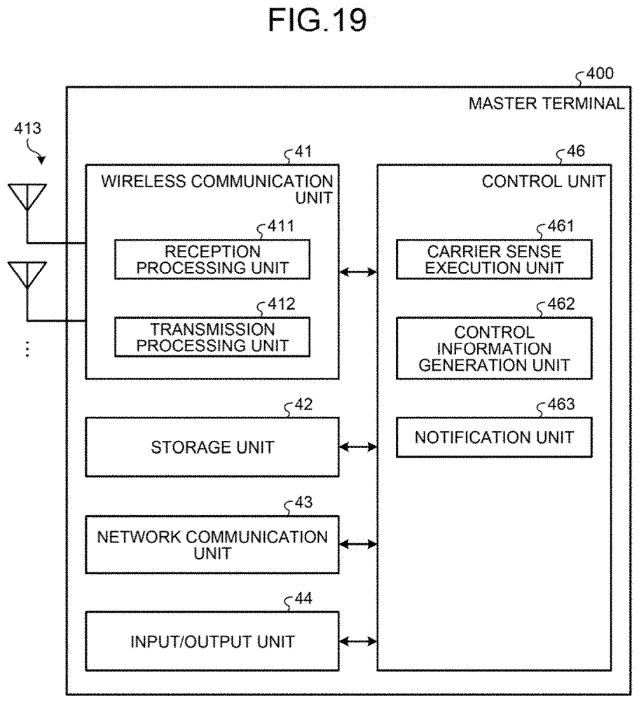

Next, the configuration of the master terminal 400 is described with reference to FIG. 19. FIG. 19 is a diagram illustrating an example of the configuration of the master terminal 400 according to the second embodiment of the present disclosure. The master terminal 400 is a mobile wireless communication device. For example, the master terminal 400 may be user equipment (UE) such as a mobile phone or a smart device. Alternatively, the master terminal 400 may be a UE-type RSU. The master terminal 400 can perform wireless communication with the base station device 20 and the base station device 30. Further, the master terminal 400 can perform sidelink communication with the mobile device 50 and another terminal device 40.

As illustrated in FIG. 19, the master terminal 400 includes the wireless communication unit 41, the storage unit 42, the network communication unit 43, the input/output unit 44, and a control unit 46. Note that the configuration illustrated in FIG. 19 is the functional configuration, and the hardware configuration may be different from the functional configuration. Further, the functions of the master terminal 400 may be distributed and implemented in a plurality of configurations physically separated. Further, in the configuration of the master terminal 400, the network communication unit 43 and the input/output unit 44 do not have to be essential constituent elements.

Note that the functional configurations of the wireless communication unit 41, the storage unit 42, the network communication unit 43, and the input/output unit 44 are the same as those of the wireless communication unit 41, the storage unit 42, the network communication unit 43, and the input/output unit 44 of the terminal device 40 illustrated in FIG. 12, and thus, the description thereof is omitted.

The control unit 46 is a controller that controls the individual units of the master terminal 400. The control unit 46 is implemented by, for example, a processor (hardware processor) such as a central processing unit (CPU) or a micro processing unit (MPU). For example, the control unit 46 is implemented in response to various programs, stored in the storage device of the master terminal 400, executed by the processor using a random access memory (RAM) or the like as a work area. Alternatively, the control unit 46 may be implemented, for example, by an integrated circuit such as an application specific integrated circuit (ASIC) or a field programmable gate array (FPGA). Each of the CPU, the MPU, the ASIC, and the FPGA can be regarded as the controller.

As described above, the control unit 46 controls the individual units of the master terminal 400, and here, a case is mainly described where the control unit 46 is given authorization from the base station device 30 and performs beam control of sidelink communication between the terminal devices 40 (or the mobile devices 50).

The control unit 46 of the master terminal 400 determines a beam to be used for the sidelink communication between the terminal devices 40 on the basis of the result of a beam measurement by the terminal device 40. Further, the control unit 46 acquires a beam report in the sidelink communication between the terminal devices 40 and executes beam recovery according to the report result.

In order to implement the functions described above, as illustrated in FIG. 19, the control unit 46 includes a carrier sense execution unit 461, a control information generation unit 462, and a notification unit 463. The blocks (the carrier sense execution unit 461 to the notification unit 463) of the control unit 46 are functional blocks indicating the functions of the control unit 46. The functional blocks may be software blocks or hardware blocks. For example, each of the functional blocks may be one software module implemented by software (including a microprogram) or one circuit block on a semiconductor chip (die). Of course, each functional block may be a single processor or a single integrated circuit. A method for configuring the functional blocks is arbitrary. Note that the control unit 46 may be configured by functional units different from the functional blocks described above.

Note that specific functional configurations of the blocks (the carrier sense execution unit 461 to the notification unit 463) of the control unit 46 are the same as those of the blocks (the carrier sense execution unit 341 to the notification unit 343) of the control unit 34 of the base station device 30 illustrated in FIG. 11, and thus, the description thereof is omitted.

### <4-3. Flow of Sidelink Communication Processing>

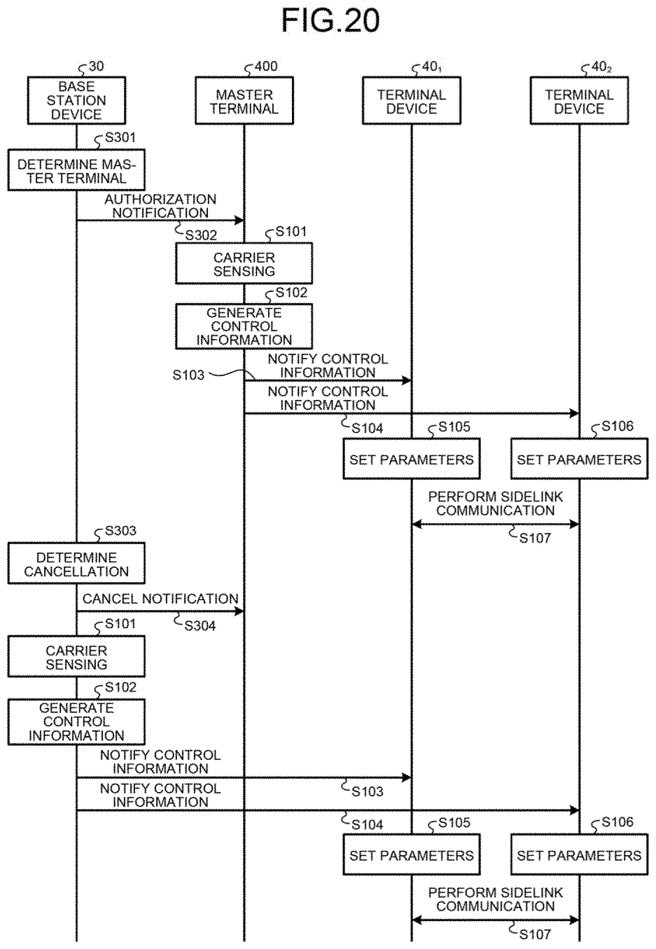

Next, FIG. 20 is a sequence diagram for explaining the flow of sidelink communication processing according to the second embodiment of the present disclosure.

As illustrated in FIG. 20, the base station device 20 determines the master terminal 400 (Step S301). The base station device 20 sends an authorization notification to the master terminal determined (Step S302). Note that, hereinafter, the processing of Steps S101 to S107 is the same as the processing of FIG. 13 except that the base station device 30 is replaced with the master terminal 400, and thus the description thereof is omitted.

Subsequently, when the base station device 30 determines to cancel the authorization of the master terminal 400 (Step S303), the base station device 30 sends a cancellation notification to the master terminal 400 (Step S304). Accordingly, when cancelling the authorization of the master terminal 400, the base station device 30 controls, instead of the master terminal 400, the sidelink communication of the terminal devices 40₁ and 40₂. Since the subsequent processing is the same as the processing of FIG. 13, the description thereof is omitted.

### <5. Modification Examples to Second Embodiment>

### <5-1. Modification Example 1>

In the second embodiment described above, the master terminal 400 determines control information for the sidelink communication of the terminal devices 40₁ and 40₂; however, for example, the master terminal 400 may determine constraints for executing carrier sense.

In such a case, the master terminal 400 includes a sensing information generation unit instead of the control information generation unit 462, as with the base station device 30 according to the modification example 1 to the first embodiment. The sensing information generation unit generates sensing information including constraints on sensing instead of the control information. The sensing information includes, for example, information on a time and frequency at which the terminal device 40 executes carrier sense and information on maximum transmission power.

As described above, even in a case where the master terminal 400 controls the sidelink communication, the master terminal 400 determines constraints for the carrier sense execution, so that the terminal device 40 can execute the carrier sense.

### <5-2. Modification Example 2>

In the second embodiment, after cancellation of the authorization of the master terminal 400, the base station device 30 controls the sidelink communication of the terminal devices 40₁ and 40₂; however, the present disclosure is not limited thereto. For example, after cancellation of the authorization of the master terminal 400, the base station device 30 may determine that another terminal device 40 is a new master terminal and give authorization thereto. This allows a master terminal different from the master terminal 400 to control the sidelink communication of the terminal devices 40₁ and 40₂.

### 6. Other Modification Examples

In the first and second embodiments of the present disclosure and the modification examples thereto, the control information generation units 342 and 462 allocate resources on the basis of the result of carrier sensing; however, the present disclosure is not limited thereto. For example, the base station device 20 or the master terminal 400 may allocate resources on the basis of machine learning.

Specifically, the base station device 30 or the master terminal 400 learns in advance a model that takes the result of carrier sensing (for example, time or frequency resources in a busy state or a vacant state) as an input and the resources to be allocated as an output. Such model learning is performed by, for example, deep learning (DNN). Alternatively, in addition to the DNN, various neural networks such as recurrent neural networks (RNN) and convolutional neural network (CNN) can be used. Further, not only a learning model using the DNN or the like, but also a learning model trained by various other machine learning such as a decision tree or a support vector machine can also be used. Note that such a model is stored in the storage units 32 and 42, for example.

The base station device 30 or the master terminal 400 uses the result of sensing by the carrier sense execution units 241 and 461 as an input, and determines a resource to be allocated to the terminal device 40 on the basis of the machine learning model. Note that the base station device 30 or the master terminal 400 may allocate resources by machine learning on the basis of, for example, positional information of the terminal device 40, and so on. As described above, the use of machine learning allows the base station device 30 or the master terminal 400 to allocate the resource used for the sidelink communication of the terminal device 40 by using information other than the result of the carrier sensing. This can omit carrier sense by the base station device 30 and reduce the processing load.

In the modification examples to the first and second embodiments of the present disclosure, the terminal device 40 executes carrier sensing, determines a resource for sidelink communication, and performs sidelink communication; however, the present disclosure is not limited thereto. For example, the terminal device 40 may determine a resource and perform sidelink communication on the basis of machine learning.

Specifically, the terminal device 40 learns in advance, for example, a model that takes the result of carrier sensing (for example, time or frequency resources in a busy state or a vacant state) as an input and the resources to be allocated as an output. Such model learning is performed by, for example, deep learning (DNN).

Alternatively, in addition to the DNN, various neural networks such as recurrent neural networks (RNN) and convolutional neural network (CNN) can be used. Further, not only a learning model using the DNN or the like, but also a learning model trained by various other machine learning such as a decision tree or a support vector machine can also be used. Note that such a model is stored in the storage unit 42, for example.

The terminal device 40 uses the result of sensing by the carrier sense execution unit 453 as an input, and determines a resource for sidelink communication on the basis of the machine learning model. Note that the terminal device 40 may determine resources by machine learning on the basis of, for example, the sensing information or positional information of the terminal device 40. As described above, the use of machine learning allows the terminal device 40 to determine the resource used for the sidelink communication by using information other than the result of the carrier sensing. This can omit carrier sense by the terminal device 40 and reduce the processing load.

In the first and second embodiments of the present disclosure and the modification examples thereto, the base station device 30 or the master terminal 400 allocates radio resources for an unlicensed band to the sidelink communication; however, the present disclosure is not limited thereto. For example, in a case where the communication requirements cannot be satisfied in the sidelink communication using the unlicensed band, the base station device 30 or the master terminal 400 may determine to use the licensed band for the sidelink communication and notify the terminal device 40 that performs the sidelink communication of the use of the licensed band.

For example, the base station device 30 or the master terminal 400 determines whether or not the requirements of the sidelink communication can be satisfied on the basis of a result of the carrier sense. Specifically, the base station device 30 or the master terminal 400 determines that the requirements cannot be satisfied, for example, in a case where the reception power exceeds a predetermined threshold as a result of the carrier sense. Alternatively, the base station device 30 or the master terminal 400 may determine that the requirements cannot be satisfied, for example, in a case where the CBR exceeds a predetermined threshold as a result of the carrier sense.

Alternatively, for example, the base station device 30 or the master terminal 400 may determine whether or not the requirements of the sidelink communication can be satisfied on the basis of a service type of the sidelink communication. As the service type, for example, there is a case where the sidelink communication is used to exchange a safety message including information on public safety. Such a safety-related service corresponds to a high-priority service. In such a case, the base station device 30 or the master terminal 400 may determine that the requirements of the sidelink communication cannot be satisfied in the unlicensed band.

In addition, other examples of the service type include a service that needs high reliability, low latency, high-speed communication, and high capacity. Also in such a case, the base station device 30 or the master terminal 400 may determine that the requirements of the sidelink communication cannot be satisfied in the unlicensed band.

In the first and second embodiments of the present disclosure and the modification examples thereto, the base station device 30 or the terminal device 40 for performing sidelink communication executes carrier sense; however, the present disclosure is not limited thereto. For example, a terminal device other than the base station device 30 or the terminal device 40 for performing sidelink communication (also referred to as a proxy terminal below) may execute carrier sense instead of the base station device 30 and the terminal device 40.

In such a case, the base station device 30 may designate a proxy terminal that executes carrier sense, or the terminal device 40 for performing sidelink communication may designate a proxy terminal that executes carrier sense. For example, the base station device 30 or the terminal device 40 for performing sidelink communication sends a request for carrier sense by proxy, which allows the proxy terminal to execute carrier sense in place thereof.

The proxy terminal notifies the base station device 30 or the terminal device 40 for performing sidelink communication of the result of the carrier sense. In a case where the base station device 30 receives the result of the carrier sense, the base station device 30 uses the result to allocate a radio resource to be used for sidelink communication between the terminal devices 40. In a case where the terminal device 40 receives the result of the carrier sense, the terminal device 40 performs sidelink communication using a resource that is in a vacant state.

In the second embodiment and the modification examples thereto, the case where there is one master terminal 400 has been described as an example; however, the base station device 30 may give authorization to a plurality of the master terminals 400. For example, in a case where a plurality of kinds of sidelink communication is performed, the base station device 30 may set the master terminal 400 for every sidelink communication. Alternatively, one master terminal 400 may be set for a plurality of kinds of sidelink communication. A plurality of master terminals 400 each of which performs beam management of one or more kinds of sidelink communication may be set. Note that, in a case where a plurality of master terminals 400 is set, it is assumed that the master terminals 400 share information with one another using the PSCCH.

In the first and second embodiments of the present disclosure and the modification examples thereto, the case where the NR sidelink communication is adopted as the radio access technology is described as an example; however, the present disclosure is not limited thereto. The technology according to the present disclosure is applicable to a radio access technology other than the NR. For example, the information processing system 1 may use the LTE as a radio access technology, or may use both the LTE and the NR. Alternatively, the information processing system 1 may use a radio access technology other than the NR and the LTE.

In addition, the base station devices 20 and 30, the terminal device 40, the mobile device 50, and the master terminal 400 of the embodiments may be implemented by a dedicated computer system or by a general-purpose computer system.

For example, a program for executing the operation described above is stored in a computer-readable recording medium such as an optical disk, a semiconductor memory, a magnetic tape, a flexible disk, or a hard disk, and distributed. Then, for example, the program is installed into a computer and the processing described above is executed, so that the control device is configured. At this time, the control device may be a device (personal computer, for example) external to the base station devices 20 and 30, the terminal device 40, the mobile device 50, or the master terminal 400. Further, the control device may be a device (the control unit 13 or a control unit 140, for example) inside the base station devices 20 and 30, the terminal device 40, the mobile device 50, or the master terminal 400.

In addition, the communication program may be stored in a disk device included in a server device over a network such as the Internet so that the communication program can be downloaded to a computer. In addition, the functions described above may be implemented by cooperation with an operating system (OS) and application software. In such a case, a portion other than the OS may be stored in a medium and distributed, or a portion other than the OS may be stored in a server device and downloaded to a computer.

Among the processing described in the embodiments, all or a part of the processing, described as automatic processing, can be performed manually, or all or a part of the processing, described as manual processing, can be performed automatically by a known method. In addition, the processing procedures, specific names, and information including various data and parameters indicated in the document and the drawings can be arbitrarily changed unless otherwise specified. For example, various types of information illustrated in the drawings are not limited to the illustrated information.

Further, the constituent elements of the individual devices illustrated in the drawings are functionally conceptual and are not necessarily configured physically as illustrated in the drawings. To be specific, the specific form of distribution and integration of the devices is not limited to the one illustrated in the drawings, and all or a part thereof can be configured by functionally or physically distributing and integrating in arbitrary units according to various loads, usage conditions, and the like.

Further, the embodiments described above can be appropriately combined to the extent that the processing contents do not contradict each other.

### 7. Conclusion

As described above, according to the embodiments of the present disclosure, the communication control device (e.g., the base station device 30 and the master terminal 400) includes the control unit (e.g., the control units 34 and 46). The control unit notifies information on carrier sense in the sidelink communication in the unlicensed band (e.g., control information and sensing information) between the first communication device (e.g., the terminal device 40₁) and the second communication device (e.g., the terminal device 40₂) to at least one of the first communication device and the second communication device.

This enables the first and second communication devices to perform the sidelink communication in the unlicensed band, which realizes efficient use of radio resources.

Although the embodiments of the present disclosure have been described above, the technical scope of the present disclosure is not limited to the embodiments described above as it is, and various modifications can be made without departing from the gist of the present disclosure. In addition, constituent elements of different embodiments and modification examples may be appropriately combined.

Further, the effects of the embodiments described in the present specification are merely examples and are not limited, and other effects may be provided.

Further, the present technology may also be configured as below.

(1) A communication control device comprising:
a control unit configured to notify at least one of a first communication device and a second communication device of information on carrier sense in sidelink communication in an unlicensed band between the first communication device and the second communication device.

(2) The communication control device according to (1), wherein
the control unit
executes carrier sense in the unlicensed band, and
notifies the information on the carrier sense on the basis of a result of the carrier sense.

(3) The communication control device according to (1) or (2), wherein
the information on the carrier sense is information for at least one of the first communication device and the second communication device to execute carrier sense in the unlicensed band.

(4) The communication control device according to any one of (1) to (3), wherein
the communication control device is given, by a base station device, authorization to notify the information on the carrier sense and notifies the information.

(5) The communication control device according to (4), wherein
the authorization of the communication control device is cancelled in response to a cancellation notification from the base station device.

(6) The communication control device according to any one of (1) to (5), wherein
the control unit
notifies, in a case where the first communication device is outside a coverage range of the communication control device, the second communication device of the information on the carrier sense addressed to the first communication device.

(7) The communication control device according to any one of (1) to (5), wherein
the control unit
gives, in a case where at least one of the first communication device and the second communication device is outside a coverage range of the communication control device, authorization to notify the information on the carrier sense to another communication control device having at least one of the first communication device and the second communication device within a coverage range of that another communication control device.

(8) A communication device for performing sidelink communication in an unlicensed band with another communication device, the communication device comprising:
a control unit configured to execute, on the basis of information on carrier sense acquired from a communication control device, the carrier sense in the unlicensed band and perform the sidelink communication on the basis of a result of the carrier sense.

(9) A communication control method comprising:
notifying at least one of a first communication device and a second communication device of information on carrier sense in sidelink communication in an unlicensed band between the first communication device and the second communication device.

(10) A communication method for performing sidelink communication in an unlicensed band with another communication device, the communication method comprising:
executing, on the basis of information on carrier sense acquired from a communication control device, the carrier sense in the unlicensed band to perform the sidelink communication on the basis of a result of the carrier sense.

### REFERENCE SIGNS LIST

1 INFORMATION PROCESSING SYSTEM
10 MANAGEMENT DEVICE
20, 30 BASE STATION DEVICE
40 TERMINAL DEVICE
50 MOBILE DEVICE
11, 33, 43 NETWORK COMMUNICATION UNIT
12, 32, 42 STORAGE UNIT
13, 34, 45 CONTROL UNIT
31, 41 WIRELESS COMMUNICATION UNIT
44 INPUT/OUTPUT UNIT
311, 411 RECEPTION PROCESSING UNIT
312, 412 TRANSMISSION PROCESSING UNIT
313, 413 ANTENNA

1. A communication control device comprising:
a control unit configured to notify at least one of a first communication device and a second communication device of information on carrier sense in sidelink communication in an unlicensed band between the first communication device and the second communication device.

2. The communication control device according to claim 1, wherein
the control unit
executes carrier sense in the unlicensed band, and
notifies the information on the carrier sense on the basis of a result of the carrier sense.

3. The communication control device according to claim 2, wherein
the information on the carrier sense is information for at least one of the first communication device and the second communication device to execute carrier sense in the unlicensed band.

4. The communication control device according to claim 3, wherein
the communication control device is given, by a base station device, authorization to notify the information on the carrier sense and notifies the information.

5. The communication control device according to claim 4, wherein
the authorization of the communication control device is cancelled in response to a cancellation notification from the base station device.

6. The communication control device according to claim 5, wherein
the control unit
notifies, in a case where the first communication device is outside a coverage range of the communication control device, the second communication device of the information on the carrier sense addressed to the first communication device.

7. The communication control device according to claim 5, wherein
the control unit
gives, in a case where at least one of the first communication device and the second communication device is outside a coverage range of the communication control device, authorization to notify the information on the carrier sense to another communication control device having at least one of the first communication device and the second communication device within a coverage range of that another communication control device.

8. A communication device for performing sidelink communication in an unlicensed band with another communication device, the communication device comprising:
a control unit configured to execute, on the basis of information on carrier sense acquired from a communication control device, the carrier sense in the unlicensed band and perform the sidelink communication on the basis of a result of the carrier sense.

9. A communication control method comprising:
notifying at least one of a first communication device and a second communication device of information on carrier sense in sidelink communication in an unlicensed band between the first communication device and the second communication device.

10. A communication method for performing sidelink communication in an unlicensed band with another communication device, the communication method comprising:
executing, on the basis of information on carrier sense acquired from a communication control device, the carrier sense in the unlicensed band to perform the sidelink communication on the basis of a result of the carrier sense.
